(19) United States
(12) Patent Application Publication
(10) Pub. No.: US 2013/0130798 A1
(43) Pub. Date: May 23, 2013

(54) VIDEO GAME CONTROLLER

(71) Applicants: Amit NIR, Caesarea (IL); Shlomo AVITAL, Caesarea (IL)

(72) Inventors: Amit NIR, Caesarea (IL); Shlomo AVITAL, Caesarea (IL)

(21) Appl. No.: 13/739,164

(22) Filed: Jan. 11, 2013

Related U.S. Application Data
(63) Continuation-in-part of application No. PCT/IL2011/000544, filed on Jan. 10, 2011.
(60) Provisional application No. 61/363,375, filed on Jul. 12, 2010.
(60) Provisional application No. 61/675,359, filed on Jul. 25, 2012.

(51) Int. Cl. A63F 13/06

(52) U.S. Cl. CPC A63F 13/06
USPC 463/36

(57) ABSTRACT

A video game controller has a main portion for receiving a person interacting with the controller. The controller has a support about which the main portion can be tilted relative to a ground face while maintaining the person interacting with the controller facing substantially the same direction. And the controller can communicate values representative of the tilt to a video game being controlled.

### TECHNICAL FIELD

Embodiments of the invention relate to methods and apparatus for interfacing a human with a video/computer game and to a video/computer game controller for interfacing and interacting with a video/computer game.

### BACKGROUND

Various devices and methods are known for interfacing a human with a computer. Among well known and ubiquitous human machine interface (HMI) devices are manually operated control devices such as a keyboard, a mouse, and a joystick. Voice recognition systems that control computers in response to vocal commands are also known. Various HMI systems that recognize a person's (user's) motions and use the recognized motions to control a computer have relatively recently been introduced into the global market. In particular HMI motion recognition systems have been used to interface a person (user) with computer games. Among well known computer game systems that respond to a user's motion are Nintendo's “Wii” and Microsoft's gesture recognition system “Kinect” for Xbox.

A video game controller HMI device may be designed to permit a person to perform a simulated physical exercise with the video game he or she is interacting with. Such a physical exercise may include aerobic exercise, anaerobic exercise, balance (etc.); and the video game with which the person interacts may be used to promote the physical exercise.

Also a video game controller may be designed to operate with video/computer games that were programmed to function with for example handheld joysticks, and adapting the video game controller to function with such video/computer games may require “mimicking” the operation of the joystick.

U.S. Pat. No. 5,645,513 describes an exercise apparatus that can be used in conjunction with a personal computer or television video game. The exercise apparatus is designed to provide entertainment and a positive mental distraction from the indoor physical exercising experience, by enabling multi-sensor feedback between the exerciser and a video game.

### SUMMARY

The following embodiments and aspects thereof are described and illustrated in conjunction with systems, tools and methods which are meant to be exemplary and illustrative, not limiting in scope.

An aspect of an embodiment of the invention relates to providing a video game controller functioning as a human machine interface (HMI) for interfacing a user with a computer game. The controller is configured to generate signals for controlling the computer game responsive to e.g. tilt of the controller caused by shift of weight or change of balance of a user that is positioned or seated on a seat of the controller. The signals generated by the controller mimic signals generated by a joystick responsive to changes in pivot angles of the joystick, so that in accordance with an embodiment of the invention the controller may be used to interface a user with off-the-shelf computer games that may be played using a conventional joystick.

In an aspect of the invention in order to provide the human user interacting with the controller with maximal possible control of tilt, a location about which tilt may be designed to occur is positioned as close as possible to the center of mass of the user. Since a human's center of mass is generally at his belly this location about which tilt occurs may be lifted above the ground face to a preferable position just below the seat upon which the person sits. The location about which the main portion of the embodiments of the controller tilts is here called a “support” and preferably the “support” is configured as a gimbal assembly having two-gimbals that allow tilt about two orthogonal axes. By this configuration, the person interacting with the embodiments of the controller may be tilted always facing substantially the same direction so that his orientation may not be lost while playing a game.

In an aspect of the invention in order to compensate for e.g. possible physiological limitation of a human user to react fast enough to changes required by a Joystick designed game, merely by shifting balance or weight, the user may physically interact with the controller in additional forms in order to mechanically enhance e.g. the tilt of the device and thus the signals and/or speed of change in signals generated by the device. Possibly such additional forms of physical interaction may be accomplished by e.g. the hands of the user interacting with the device and/or by shifting the center of mass of the user's body laterally relative to a pivot area or as here called a “support” of the device. Additionally or alternatively, enhancing the signals and/or speed of change in signals generated by the controller may be accomplished by software by manipulating the outputted signals representative of tilt that are transmitted towards the game by software implemented code or algorithm.

Another aspect of an embodiment of the invention relates to implementing the video game controller as an exercise bicycle, hereinafter also referred to as an “HMI exercycle”, for interfacing a user with a computer game that is configured to generate signals for controlling the computer game responsive to attitude and/or position of a seat of the HMI exercycle on which the user sits. The signals generated by the HMI exercycle responsive to changes in seat attitude mimic signals generated by a joystick responsive to changes in pivot angles of the joystick. An HMI exercycle in accordance with an embodiment of the invention may therefore be used to interface a user with off-the-shelf computer games that may be played using a conventional joystick. Possibly, here too signals and/or speed of change in signals generated by the controller may be enhanced mechanically or by software in order to compensate for e.g. physiological limitations of a human user to react fast enough to changes required by a Joystick designed game.

In an embodiment of the invention the controller seat is mounted to a support rail that is coupled to a gimbal assembly (here also referred to as a “support”) having, optionally a plurality of axes of rotation. Optionally, the seat is mounted to the support rail so that it may be translated along the support rail. The user changes attitude of the seat, and optionally location of the seat along the support rail, by shifting his or her body, and/or manipulating a handlebar to rotate the support rail relative to the axes. The handlebar is rotatable, optionally about a plurality of axes and may be coupled to the support rail by a system of control cables and pulleys. The user may change the attitude of the seat selectively about each of the gimbal axes by rotating the handlebars about a corresponding handlebar axes of rotation. In an embodiment of the invention, the handlebars are coupled to the seat so that they are rotatable about an axis of the plurality of axes over a range, hereinafter a “free range”, of angles to generate control signals without rotating the gimbal assembly about a corresponding axis. By shifting weight and/or operating the handlebars to change attitude of the seat, and/or rotating the handlebars through a free range of angles, a user can generate signals that keep up with and provide effective interaction with a changing environment of a computer game.

An aspect of one embodiment of the invention relates to a video game controller comprising a main portion for receiving a person interacting with the controller. The controller comprises a “support” in an optional form of a two-gimbal assembly that can support tilt about only two orthogonal axes, so that the person being tilted always faces substantially the same direction in order to reduce possible miss orientation he may encounter. The controller also communicates values representative of the tilt to a video game being controlled and the person interacting with the controller can affect the tilting of the main portion by shifting of weight and by moving at least one movable segment of the main portion. The movable segment may be a seat upon which the person is seated or a handle bars, and by moving the movable segment the person can mechanically enhance for example a tilt of the main portion in a certain given direction.

In one aspect of the invention the two-gimbal assembly support is located as close as possible below the seat in order to increase the ability of the person interacting with the controller to easily control the tilting of the main portion. For that purpose in embodiments of the invention where the controller is for example in the form of an exercise bicycle (“HMI exercycle”) with foot lever pedals, the foot levers are attached to an adjustable arm that can be pivoted in order to increase or decrease a distance of the foot levers from the seat. This manner of adjustment maintains the two-gimbal assembly support at its preferable location as close as possible below the seat while the controller is being fitted for use with users having different heights.

An aspect of one embodiment of the invention also relates to a video game controller with a main portion for accommodating a person, which can be tilted about a support that supports tilt only about two orthogonal axes. The controller communicates values representative of the tilt to a video game being controlled, and the person can affect the tilting by shifting of weight. Here the main portion comprises again a movable segment however in this embodiment the segment can move up to a limit without affecting tilt of the main portion but only change to values representative of the tilt. And moving the segment beyond the limit affects both tilt and consequently changes in values representative of tilt. This ability to easily and freely move the segment up to the limit allows the person to quickly react to changing scenarios in a game he is playing, similar to a joystick. The movable segment may be implemented as a handle bar.

In one aspect of the invention in addition to mechanically enhancing the tilt and/or read values of tilt and/or values representative of tilt, by e.g. the movable segment, the controller may also (or instead) manipulate by software the values representative of tilt that are communicated to the video game in order to compensate for the slower reaction of this “human activated joystick” of at least some embodiments of the present invention. This may be implemented by taking a value indicative of read tilt of the main portion and transforming it to a different value that is communicated to the video game which is the value representative of tilt.

In an aspect of the present invention, the value indicative of read tilt may be equal to the actual angle of tilt that the main portion of the controller tilts about a certain axes after being magnified by a certain ratio. This magnification may transform the relatively small tilt angles that the main portion of the controller may be limited to tilt in, to larger tilt angles that a hand held joystick can tilt. The limitation of tilt angle of the main portion may be in order to avoid tilting the main portion to an angle range where the person interacting with the controller may lose orientation and/or feel uncomfortable. And the magnification may assist in transforming these relatively small actual tilt angles of the main portion to larger angle values that “mimic” the tilt angles that a joystick with which a video game being controlled by embodiments of the controller, may be originally designed to be operate with. The tilt angles of the main portion may be read by e.g. a potentiometer or encoder and possibly this read value may be further increased or manipulated. Transformation from read angles of tilt to value representative of tilt may be formed by e.g. a look up table, a linear equation, a non-linear equation (etc); that correlate the value indicative of read tilt to another value here accordingly named “representative of tilt” that is transmitted to the video game.

In an embodiment there is provided a video game controller or Human Interface Device (HMI device) that comprises a main portion that is adapted to receive a person/user interacting with the controller, the main portion comprises a support that is adapted to facilitate tilting of the main portion relative to a ground face above which it is located and the controller being adapted to provide a report representative of the tilt to a video game being controlled, wherein the tilting of the main portion is in any direction towards which the person shifts his weight.

Preferably, the full weight of the person interacting with the controller bears on the main portion of the HMI device or controller.

Optionally, the HMI device or controller comprises a biasing mechanism that is adapted to apply at least one biasing force that urges the main portion of the HMI device or controller towards a normal position relative to the ground face and the tilt of the main portion is in any direction away from the normal position.

Further optionally, the person received upon the main portion is located substantially above the support when the main portion is in the normal position.

Typically, the main portion comprises a seat on which the person received upon the device can sit, the seat being adapted to be tilted together with the support and being located substantially above the support when the main portion is in the normal position.

Optionally, the support comprises at least a partially spherical face culminating in an apex, and the support engages with its face a surface upon which it is adapted to rock in order to facilitate the tilting of the main portion.

If desired, the support engages the surface with its apex when the main portion is in the normal position.

Optionally, the biasing mechanism comprises an adjuster that is adapted to adjust the at least one biasing force that is applied upon the main portion of the HMI device or controller.

Further optionally, the adjustments of the at least one biasing force includes increasing or decreasing the at least one biasing force.

If desired, the HMI device or controller comprises foot levers for interaction with the feet of the person using the HMI device or controller, the foot levers being adapted to be tilted together with the support of the main portion and being adapted each to perform a movement relative to the support, and the HMI device or controller being adapted to provide a report representative of the movement of the foot levers to the video game being controlled.

Typically, the foot levers are pedals and the movement one pedal urges a corresponding movement of the other pedal.

Optionally, the HMI device or controller comprises hand levers for interaction with the hands of the person using the HMI device or controller, the hand levers being adapted to be tilted together with the support of the main portion and being adapted each to perform a movement relative to the support, and the HMI device or controller being adapted to provide a report representative of the movement of the hand levers to the video game being controlled.

If desired, the movement of one hand lever is independent of the movement of the other hand lever.

Optionally, equal movement of the hand levers in a similar direction towards or away from the person interacting with the HMI device or controller is adapted to urge a vertical change in a position of an object or the point of view of an object that exists in a video game virtual environment that is controlled by the HMI device or controller.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 shows a perspective view of a person seated on a HMI device or video game controller in accordance with an embodiment of the present invention with his feet engaged with pedals of the HMI device or controller and his hands engaged with hand levers of the HMI device or controller;

FIG. 2 shows a perspective view of the HMI device or video game controller;

FIGS. 3A to 3C show side views of different tilted states of the HMI exercycle or video game controller;

FIGS. 4A to 4C show front views of different tilted states of the HMI exercycle or video game controller;

FIGS. 5A to 5D show perspective views of various orientations that the hand levers of the HMI device or controller can be manipulated to;

FIGS. 6A and 6B show embodiments of toggles that are located on the hand levers of the HMI device or controller;

FIG. 7 shows a perspective top view of a lower part of the HMI device or video game controller including an embodiment of a support and a base of the HMI device or controller;

FIG. 8 shows a perspective bottom view of the support;

FIG. 9 shows a perspective top view of the base;

FIGS. 10 and 11 show perspective top views of the lower part of the HMI device or video game controller exhibiting an embodiment of a biasing mechanism of the HMI device or controller;

FIG. 12 schematically shows exemplary changes in vertical and horizontal positions or points of view of an object in a video game virtual environment that is being controlled by a HMI device or controller in accordance with an embodiment of the invention;

FIG. 13 schematically shows a perspective view of a HMI device or video game controller in accordance with another embodiment of the present invention;

FIG. 14 schematically shows a front view of the HMI device or video game controller of FIG. 13;

FIG. 15 schematically shows a side view of the HMI device or video game controller of FIG. 13;

FIG. 16 schematically shows an exploded view of a portion of the HMI device or video game controller of FIG. 13 that facilitates its tilting relative to the ground;

FIGS. 17 to 19 schematically show various non exploded views of the portion of the video game that is seen in FIG. 16;

FIG. 20 schematically shows a front view of the HMI device or video game controller of FIG. 13 with its main portion tilted to one of its sides;

FIG. 21 schematically shows a front view of the HMI device or video game controller of FIG. 13 with its main portion tilted to its other side;

FIG. 22 schematically shows a side view of the HMI device or video game controller of FIG. 13 with its main portion tilted forwardly;

FIG. 23 schematically shows a side view of the HMI device or video game controller of FIG. 13 with its main portion tilted backwards;

FIGS. 24A and 24B schematically show other embodiments of the HMI device or video game controller;

FIG. 24C shows an embodiment of an algorithm for transforming read tilt angles of the controller to transformed angles communicated to the video game;

FIG. 25A schematically shows a HMI device or video game controller configured to interface a user with a computer, in accordance with an embodiment of the invention;

FIGS. 25B-25C schematically show enlarged views of features of the HMI device or controller shown in FIG. 25A, in accordance with an embodiment of the invention;

FIGS. 25D-25F schematically show a user changing roll and pitch angles of a seat of a HMI device or controller in accordance with an embodiment of the invention;

FIG. 26 schematically shows another HMI device or video game controller, in accordance with an embodiment of the invention;

FIG. 26A schematically shows an enlarged portion of FIG. 26;

FIGS. 27A and 27B schematically show left and right hand side views of a portion of a HMI device or controller having pedals mounted to a cantilever arm, in accordance with an embodiment of the invention; and

FIGS. 28A-28E show respectively: perspective, right-side, left-side, front and back views, of yet another HMI device or video game controller in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

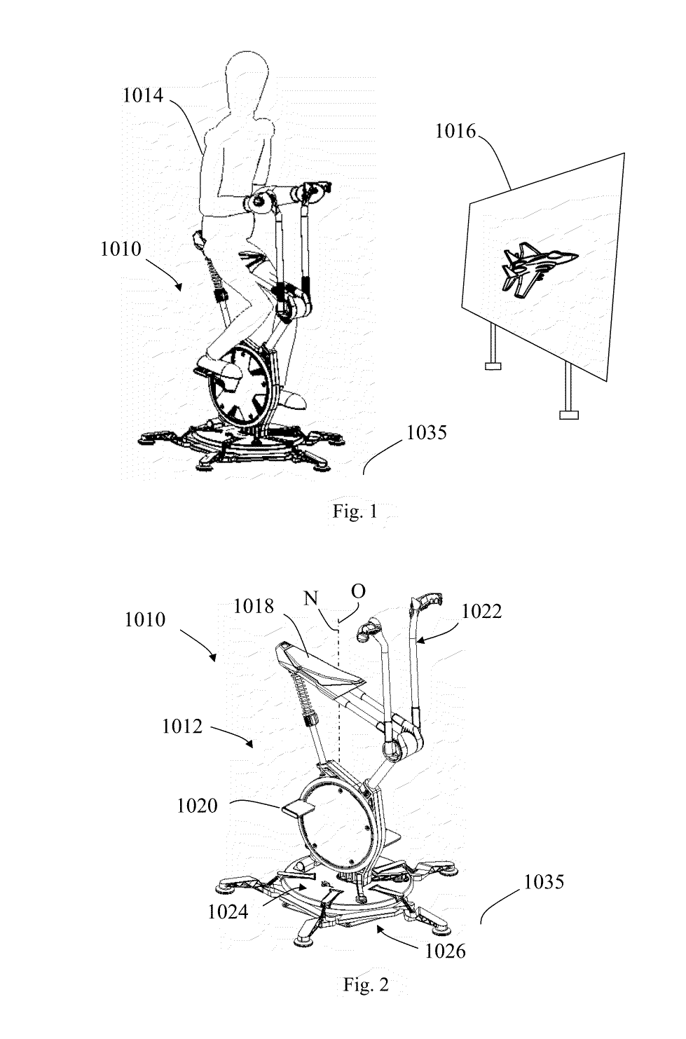

Attention is first drawn to FIGS. 1 and 2. A video game controller/HMI device 1010 in accordance with an embodiment of the invention has a main portion 1012 that is adapted to receive a person/user 1014 using the controller 1010. The person 1014 can interact with the controller 1010 to produce output signals that are read and/or reported to a computerized device (not shown), and a visual feedback can for example be generated on a video display 1016 that is in communication with the computerized device. The computerized device can be a video game console, a personal computer (etc.) and the video display 1016 can be a television, a monitor (etc.) that displays for example a video game that is run by the computerized device and controlled by the controller 1010.

The main portion 1012 of the video game controller 1010 has a seat 1018, a pair of foot levers 1020 in the form of pedals and a handlebar 1022; and the person 1014 using the controller 1010 can engage the handlebar 1022 with his hands and the foot levers 1020 with his feet while sitting on the seat 1018 (or standing up) as part of his interaction with the controller 1010. In an embodiment of the invention, such interaction of the person 1014 with the controller 1010 may urge the person 1014 to undergo a physical exercising experience that includes feedback between the exercising person 1014 and the video game he is controlling.

It should be noted that directional terms appearing throughout the specification and claims, e.g. “forward”, “rear”, “up”, “down” etc., (and derivatives thereof) are for illustrative purposes only, and are not intended to limit the scope of the appended claims. In addition it is noted that the directional terms “down”, “below” and “lower” (and derivatives thereof) define identical directions.

Attention is additionally drawn to FIGS. 7 to 9. In an embodiment, the main portion 1012 of the controller 1010 has a support 1024 at its lower side and the controller 1010 has a base 1026 below the support 1024 that the support 1024 is adapted to engage. The base 1026 has at its upper side a planar floor 1028 that is surrounded by a plurality of limits 1030 and the support 1024 has at its lower side a partially spherical pivot face 1032 that culminates in an apex 1034. The pivot face 1032 of the support 1024 is adapted to rock upon the floor 1028 of the base 1026 in order to facilitate tilting of the main portion 1012 of the controller 1010 relative to the base 1026 and to the ground face 1035 above which it is located and such tilting is limited up to the limits 1030 which the pivot face 1032 may engage if tilted to a certain level.

A normal axis N of the controller 1010 is defined perpendicular to the floor 1028 of the base 1026 and thereby also perpendicular to the ground face 1035 upon which the base 1026 is located, and an operative axis O of the controller 1010 that is fixed to the portions of the controller 1010 that are adapted to be tilted is defined as passing through the apex 1034 of the support 1024 with the pivot face 1032 of the support 1024 being symmetrically formed thereabout.

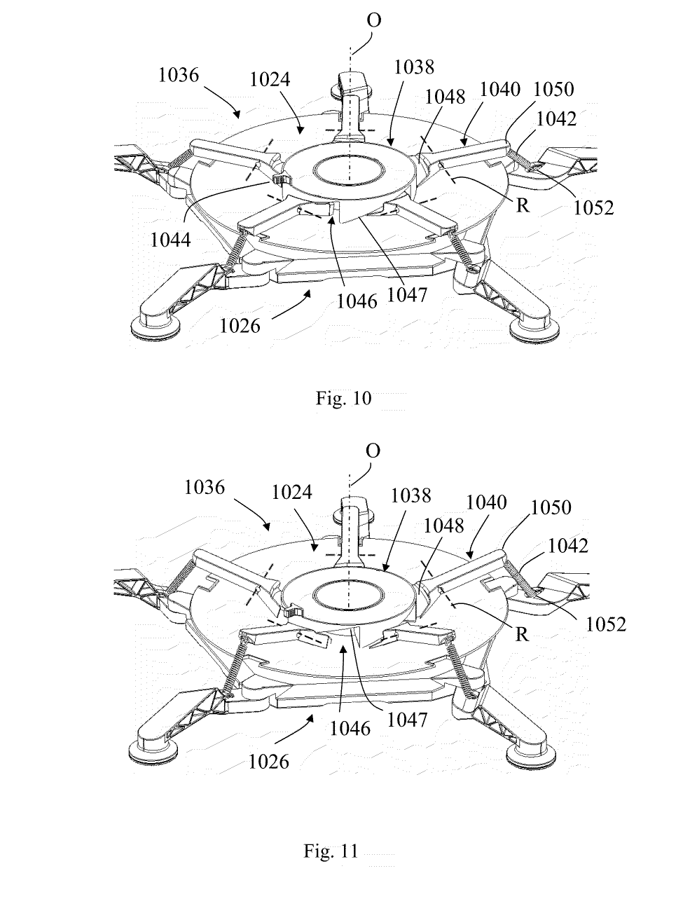

Attention is additionally drawn to FIGS. 10 and 11. In an embodiment, the controller 1010 has a biasing mechanism 1036 that is adapted to apply biasing forces that urge the support 1024 and thereby the main portion 1012 of the controller 1010 towards a normal position relative to the ground face 1035 in which the operative axis O and the normal axis N are aligned. The biasing mechanism 1036 is optionally located at a top side of the support 1024 and is adapted to be tilted together with the support 1024 and therefore the biasing mechanism 1036 will be described herein below with reference to the operative axis O that is fixed to the tilting parts of the controller 1010.

The biasing mechanism 1036 has a central circular core 1038, a plurality of arms 1040 and a plurality of biasing means 1042 in an optional form of springs that are associated each with a respective one of the arms 1040. The core 1038 has an optional lever 1044 attached to its upper side that is adapted to enable rotation of the core 1038 about the operative axis O and the core 1038 has a serrated lower side that includes a series of saw-teeth shaped recesses 1046 that are symmetrically distributed about the operative axis O. Each recess 1046 is bound at its upper side by an upper wall 1047 that ramps down from one side of the recess 1046 where the depth of the recess 1046 along the operative axis O is maximal to another side where the depth of the recess 1046 has diminished. Each arm 1040 of the biasing mechanism 1036 extends radially outwardly away from the operative axis O with an inner end 1048 thereof being located in a respective one of the recesses 1046 and an outer end 1050 thereof being coupled by its biasing means 1042 to an associated respective anchor 1052 on the base 1026 of the controller 1010.

Each arm 1040 is pivotally fixed to the support 1024 in such a way that it can be pivoted about a respective axis R that facilitates its inner and outer ends 1048, 1050 to be shifted upwards and downwards. In the controller 1010 the core 1038 may be rotated about the operative axis O between an initial state and a terminal state.

In the initial state (as seen in FIG. 10) each recess 1046 is positioned in relation to its arm 1040 in such a way that the inner end 1048 of the arm 1040 is located in an area of the recess 1046 that has maximal depth. Each arm 1040 is constantly biased to pivot about its respective axis R by its biasing means 1042 to a position where its inner end 1048 engages the upper wall 1047 of the recess 1046. As a result, in the initial state of the core 1038 each arm 1040 is able to pivot about its respective axis R to a position where its outer end 1050 is most proximal to its associated anchor 1052 on the base 1026.

On the other hand, in the terminal state (as seen in FIG. 11) each recess 1046 is positioned in relation to its arm 1040 in such a way that the inner end 1048 of the arm 1040 is located in an area of the recess 1046 that has minimal (or no) depth. As a result, by rotating the core 1038 towards the terminal state the upper wall 1047 of each recess 1046 engages the inner end 1048 of its associated arm 1040 and urges the arm 1040 to pivot about its respective axes R towards a position where the outer end 1050 of the arm 1040 is located more distal of its associated anchor 1052 on the base 1026.

In the initial state of the core 1038, the short distance between the outer end 1050 of each the arm 1040 and its associated anchor 1052 result in each biasing means 1042 applying a first biasing force upon the support 1024 (and thereby the main portion 1012 of the controller 1010). In the terminal state of the core 1038, the larger distance between the outer end of each the arm 1040 and its associated anchor 1052 result in each biasing means 1042 applying a second biasing force that is greater than the first biasing force.

Therefore, by maneuvering the core 1038 between the initial and terminal states it is possible to adjust the biasing forces that are applied by the biasing mechanism 1036 to urge the support 1024 (and thereby the main portion 1012 of the controller 1010) towards the normal position. Such adjustment may be used for example to adjust the controller 1010 for use with people 1014 that have different weights and that would like to enjoy a generally similar sensitivity of the controller 1010 to tilting.

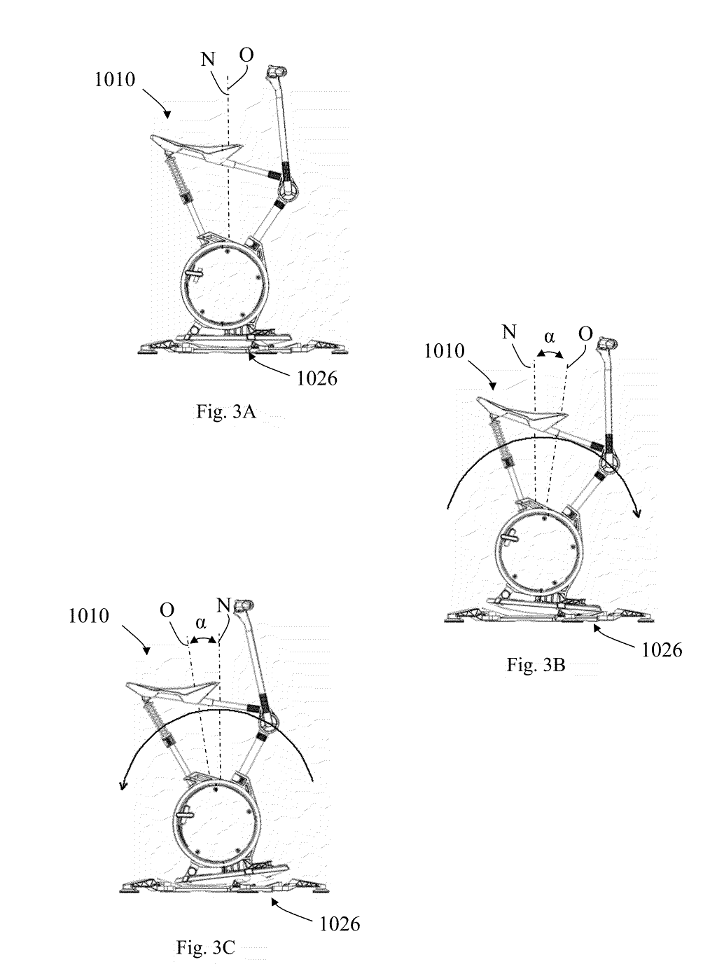

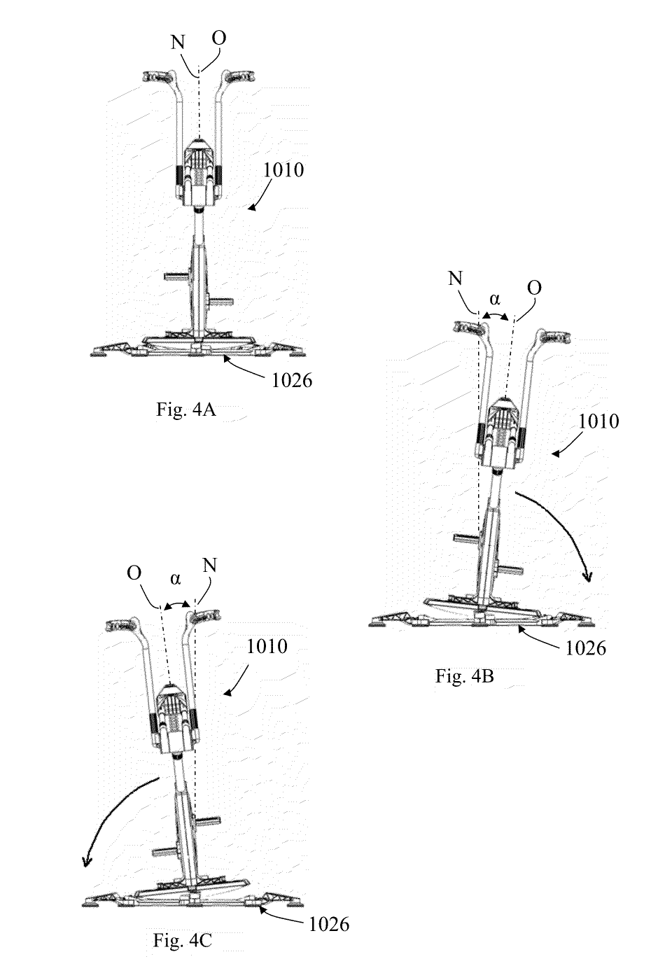

Attention is now drawn to FIGS. 3A to 3C and FIGS. 4A to 4C. The person 1014 interacting with the controller 1010 may shift his weight in a sideways direction away and towards the normal axis N in order to tilt the main portion 1012 of the controller 1010 in that direction in relation to the base 1026 of the controller 1010 and the ground face 1035. Such tilting may be defined by variations of an angle a that is formed between the operative and normal axes O, N wherein when the axes O, N are aligned (as seen in FIGS. 3A and 4A) a is zero.

Tilting of the main portion 1012 of the controller 1010 may be used to form a value representative of the tilt that is read or reported to the computerized device with which the controller 1010 is used so that a person 1014 using the controller 1010 may tilt the main portion 1012 of the controller 1010 similarly to a conventional joystick in order to interact with and control a video game that is run by the computerized device. In addition to tilting (or in place of tilting), the person 1014 using the controller 1010 may in an embodiment of the invention also pedal with his feet the optional foot levers 1020 of the controller 1010 and such pedaling may also be used to form a value representative of the pedaling that is read or reported to the computerized device with which the controller 1010 is used in order to interact with and control a video game that is run by the computerized device.

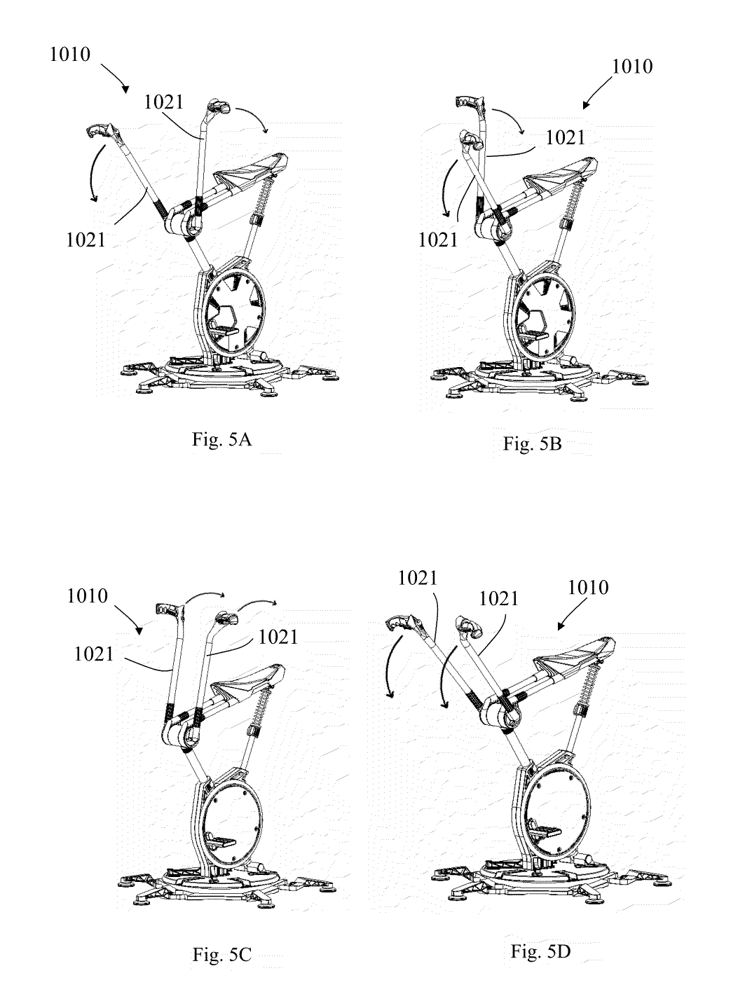

Attention is now drawn to FIGS. 5A to 5D. In an embodiment of the invention, the person 1014 interacting with the controller 1010 may also manipulate the handlebar 1022 of the controller 1010 with his hands. Optionally, the handlebar 1022 is made of two portions 1021 that can be moved independently in relation to each other. The two portions 1021 of the handlebar 1022 may be moved in opposing direction as seen in FIGS. 5A and 5B or may be moved in similar directions as seen in FIGS. 5C and 5D and the movement of each portion 1021 of the handlebar 1022 may be used to form a value representative of the movement that is read or reported to the computerized device with which the controller 1010 is used in order to interact with and control a video game that is run by the computerized device.

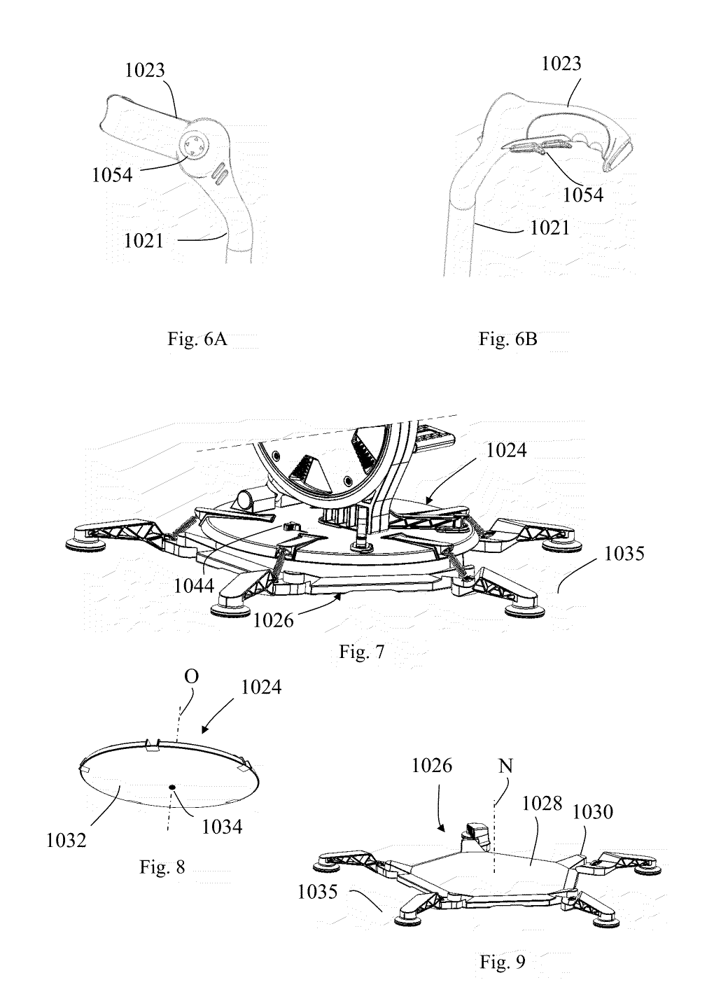

As seen in FIGS. 6A and 6B the handlebar 1022 may include toggles 1054 in the form of push-buttons and/or finger-operated joysticks whose state can be read by the computerized device or can be reported to the computerized device with which the controller 1010 is used in order to interact with and control a video game that is run by the computerized device. In an embodiment, the toggles 1054 are positioned on portions 1023 of the handlebar 1022 that extend generally parallel to the ground face 1035 above which the controller 1010 is located.

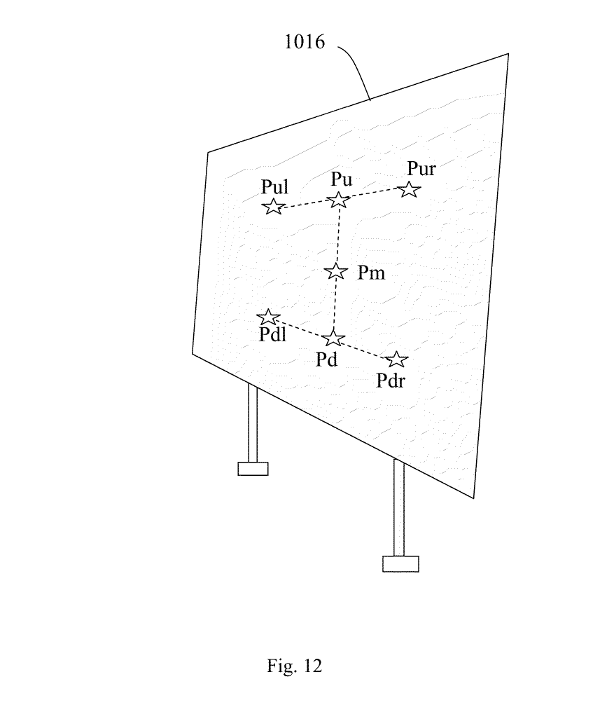

Attention is drawn to FIG. 12. The controller 1010 can be operated by the person 1014 in order to control a display of the computerized device that is used with a video game. Such use of the controller 1010 can be used for example to control a position of an object and/or a point of view of an object in a virtual environment of the video game, and this will be now described with reference to exemplary locations Pm, Pu, Pur, Pul, Pd, Pdr, Pdl that are shown on the video display 1016.

In an embodiment, the handlebar 1022 alone can be used to control the aforementioned locations that are associated with the object. From an exemplary initial location Pm, vertical changes can be achieved by either equally pulling or pushing both portions 1021 of the handlebar 1022 respectively towards the user 1014 or away from the user 1014. By equally pulling both portions 1021 of the handlebar 1022 towards the user (as seen in FIG. 5C) the position of the object and/or the point of view of the object can be vertically shifted upwardly towards location Pu on the video display 1016, and by equally pushing both portions 1021 of the handlebar 1022 away from the user (as seen in FIG. 5D) the position of the object and/or the point of view of the object can be vertically shifted downwardly towards location Pd on the video display 1016.

From exemplary positions Pu or Pd, horizontal changes in the location associated with the object can be achieved by for example pulling or pushing only one of the portions 1021 of the handlebar 1022 respectively towards the user 1014 or away from the user 1014. In an embodiment, by pulling the right portion 1021 of the handlebar 1022 towards the user 1014 the position of the object or the point of view of the object can be horizontally shifted for example to the right towards locations Pur or Pdr, and by pulling the left portion 1021 of the handlebar 1022 towards the user 1014 the position of the object and/or the point of view of the object can be horizontally shifted for example to the left towards locations Pul or Pdl.

In an embodiment of the invention, the tilting of the main portion 1012 of the controller 1010 can be also used alone or in conjunction with the handlebar 1022 in order to shift and control the position of the object or the point of view of the object on the video display 1016. In addition, in an embodiment, the user by pedaling the foot levers 1020 can urge change in a property associated with the position of the object or the point of view of the object such as a speed or acceleration of progress of the object in the virtual environment of the video game.

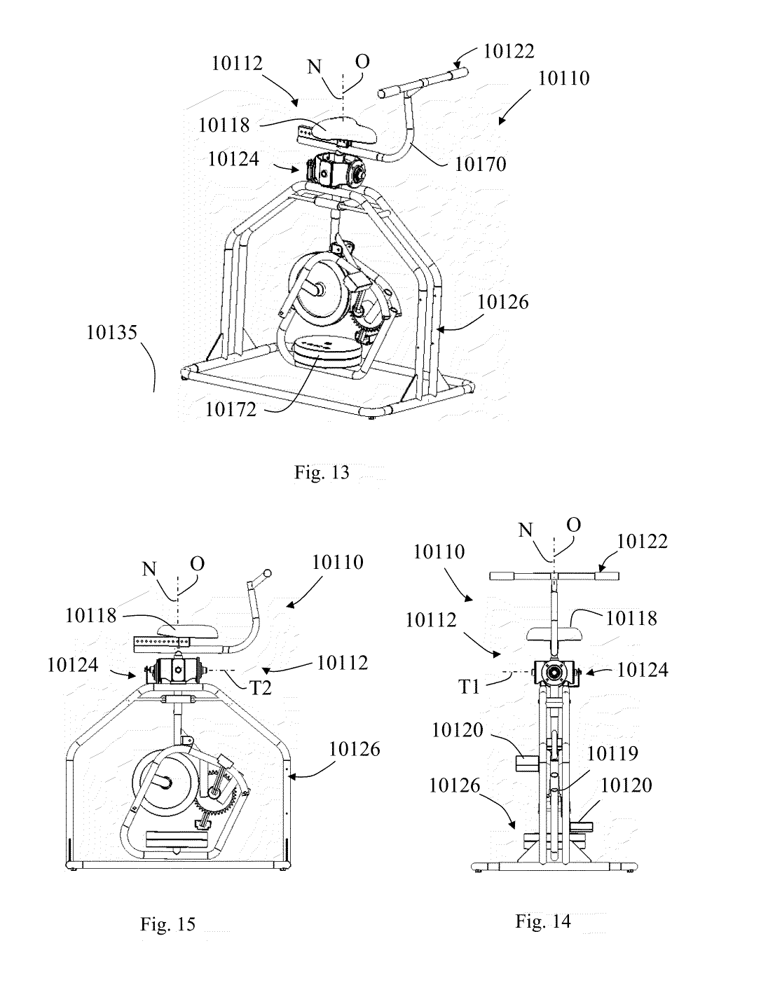

Attention is drawn to FIGS. 13 to 15. In another embodiment of the present invention a main portion 10112 of an embodiment of the video game controller/HMI device 10110 has a seat 10118, a pair of foot levers 10120 in the form of pedals and a handlebar 10122; and a person/user using the controller 10110 can engage the handlebar 10122 with his hands and the foot levers 10120 with his feet while sitting on the seat 10118 (or standing up) as part of his interaction with the controller 10110. The video game controller 10110 also has a base/floor stand 10126 in the form of a frame that is positioned on the ground face 10135 and the main portion 10112 of a controller 10110 has a support 10124 that is located adjacently below the seat 10118 where it engages the base 10126. It is noted that the support 10124 is located close to the seat 10118 and between the seat 10118 and a lower part 10119 of the main portion 10112 where the foot levers 10120 are fitted.

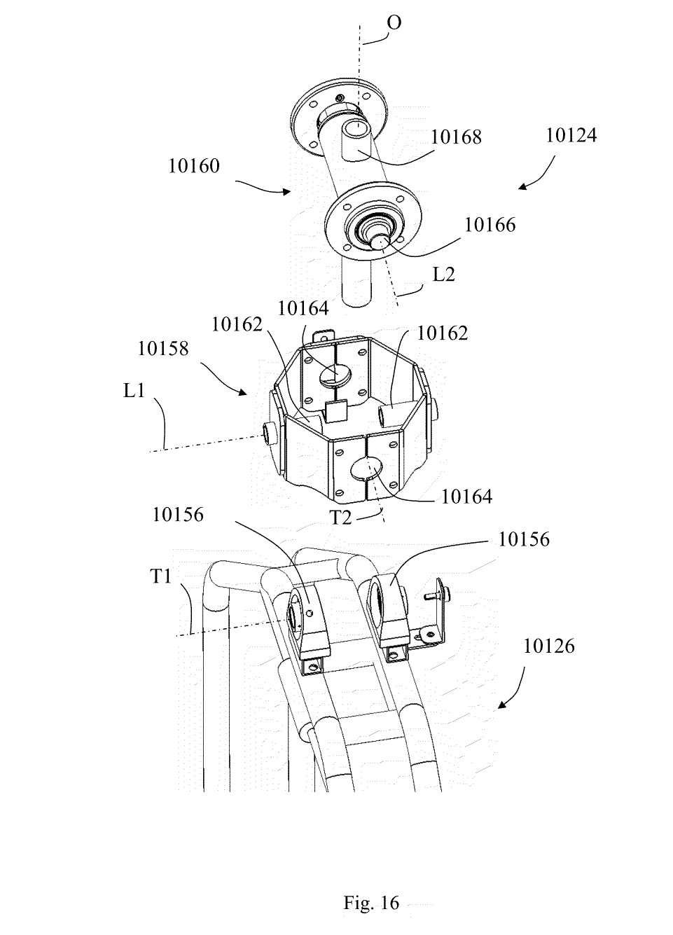

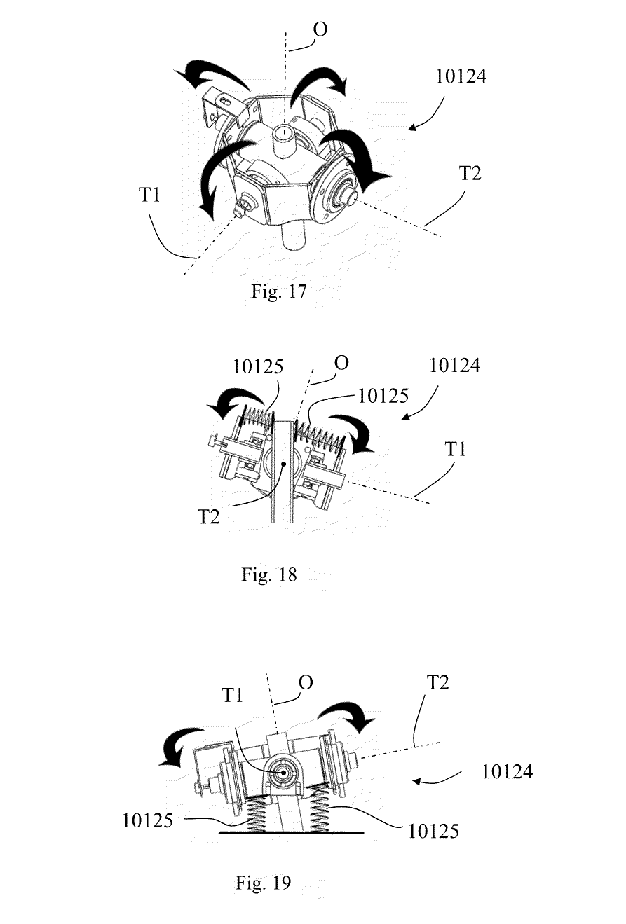

Attention is additionally drawn to FIGS. 16 to 19 to describe the interaction between the support 10124 and the base 10126 which is in the embodiment here is in the form of a set of two “gimbals”, one mounted on the other with pivot axes that are orthogonal one to the other. The base 10126 has at it upper end two anchors 10156 with an aperture extending through each anchor 10156 and both apertures are formed about a pivot axis T1 that is parallel to the ground face 10135. The support 10124 has a first part 10158 and a second part 10160. The first part 10158 has two pins 10162 that extend along a line L1 and two holes 10164 that are both formed about a pivot axis T2 that extends perpendicular to line L1 . The second part 10160 has two rods 10166 (only one is clearly seen) that extend along a line L2 and a shaft 10168 that extends along an operative axis O of the controller 10110 that is perpendicular to line L2.

In the controller 10110 each pin 10162 of the first part 10158 of the support 10124 is fitted into a respective aperture of one of the anchors 10156 of the base 10126 so that line L1 is brought to be aligned with axis T1 to form the first “gimbal”. The pins 10162 can rotate within the apertures of their anchors 10156 and as a result the first part 10158 of the support 10124 can pivot about axis T1 relative to the base 10126 and to the ground face 10135. In addition, each rod 10166 of the second part 10160 of the support 10124 is fitted into a respective hole 10164 of the first part 10158 of the support 10124 so that line L2 is brought to be aligned with axis T2 to form the second “gimbal”. The rods 10166 can rotate within their holes 10164 and as a result the second part 10160 of the support 10124 can pivot about axis T2 relative to the first part 10158 of the support 10124.

With attention to FIGS. 18 and 19 it can be seen that biasing means 10125 in the optional form of springs are fitted to the “gimbals” in order to urge them back to return to a “center” state each time the main portion 10112 is tilted away from the “center” state relative to the ground face 10135. The “center” state is defined as the position where axes O and N are aligned and the main portion 10112 of controller 10110 is not tilted relative to the ground face 10135. This spring return to “center” of the main portion 10112 has been found by the inventors to increase the ability to successfully control for example video games with the controller 10110. Slight tilts of the main portion 10112 that may be required when playing a game can be easily damped and stopped by the biasing means 10125 that accordingly act to return the main portion 10112 to its “center”.

The shaft 10168 of the second part 10160 of the support 10124 extends up to the seat 10118 and down to the lower part 10119 of the main portion 10112 where the foot levers 10120 are fitted so that the seat 10118 the lower part 10119 of the main portion 10112 are rigidly fixed to each other. The seat 10118 of controller 10110 is rigidly fixed via a bar 10170 to the handlebar 10122 of controller 10110 and an optional counter weight 10172 is fixed to the main portion 10112 of controller 10110 at a position below the lower part 10119 of the main portion 10112. The counter weight 10172 is adapted to urge the main portion 10112 of the controller 10110 back towards its “center” state relative to the ground face 10135 (bar 10170 and counter weight 10172 are indicated in FIG. 13) each time the main portion 10112 it tilted away from this state. The interaction between the support 10124 and the base 10126 of controller 10110 facilitates tilting of the main portion 10112 about pivot axes T1 and/or T2 that are orthogonal one to the other.

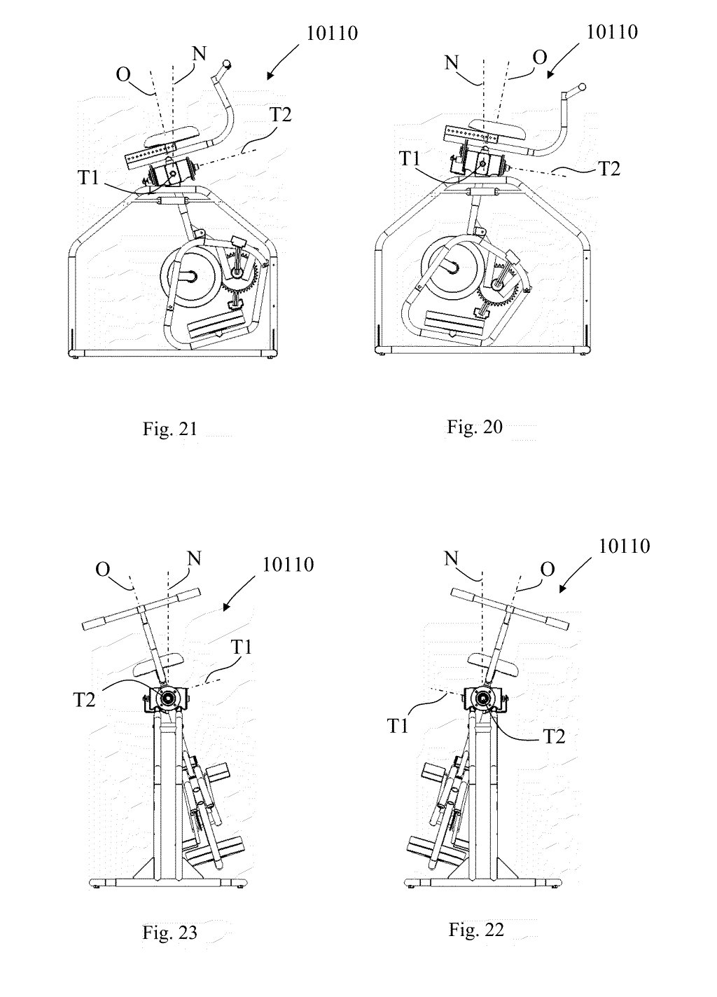

With attention to FIGS. 20 and 21 it can be seen how tilting about axis T1 can facilitate tilting of the main portion 10112 of controller 10110 in a forward or an opposing backward direction to form a “pitch angle” between the operative axis O that is fixed to the tilting main portion 10112 and an axis N that is normal to the ground face 10135. With attention to FIGS. 22 and 23 it can be seen how tilting about axis T2 can facilitate tilting of the main portion 10112 of controller 10110 to opposing lateral sides of the controller 10110 to similarly form a “roll angle” between the operative axis O that is fixed to the tilting main portion 10112 and axis N that is normal to the ground face 10135.

Tilting of controller 10110 by use of the two “gimbal” mechanism described above ensures that a person using the controller 10110 undergoes a physical experience in which he always faces substantially the same forward direction. This has been found in some cases to reduce miss orientation that may occur while tilting such a controller in order to control a game. In addition, the tilting together of the seat 10118, handle bar 10122 and lower part 10119 of the main portion 10112 with which the person using the controller 10110 interacts, has been found by the inventors to impart to the person using the controller a physical experience that resembles the experience he may encounter when riding for example a real bike or bicycle in changing terrain. These physical experiences that are provided in controller 10110 have been found by the inventors to impart to a person using controller 10110 a more intuitive feel which resembles “real life” experiences he is already familiar with.

Also it is noted that the location of the support 10124 in controller 10110 adjacently below the seat 10118 forms a pivoting point in controller 10110 for pitch and roll tilting which is located close to the center of mass of the person using the controller 10110 which is generally at the belly of the person. This close proximity of the support 10124 to the person's center of mass has been found to ease the ability to of a person using the controller 10110 to tilt the main portion 10112 to desired angles when using the controller 10110 to play a game.

Tilting of the main portion 10112 of the controller 10110 may be used to form a value representative of the tilt that is read or reported to a computerized device with which the controller 10110 is used so that a person using the controller 10110 may tilt the main portion 10112 of the controller 10110 similarly to a conventional joystick in order to interact with and control a video game that is run by the computerized device. In addition to tilting (or in place of tilting), the person using the controller 10110 may in an embodiment of the invention also pedal with his feet the optional foot levers 10120 of the controller 10110 and such pedaling may also be used to form a value representative of the pedaling that is read or reported to the computerized device with which the controller 10110 is used in order to interact with and control a video game that is run by the computerized device.

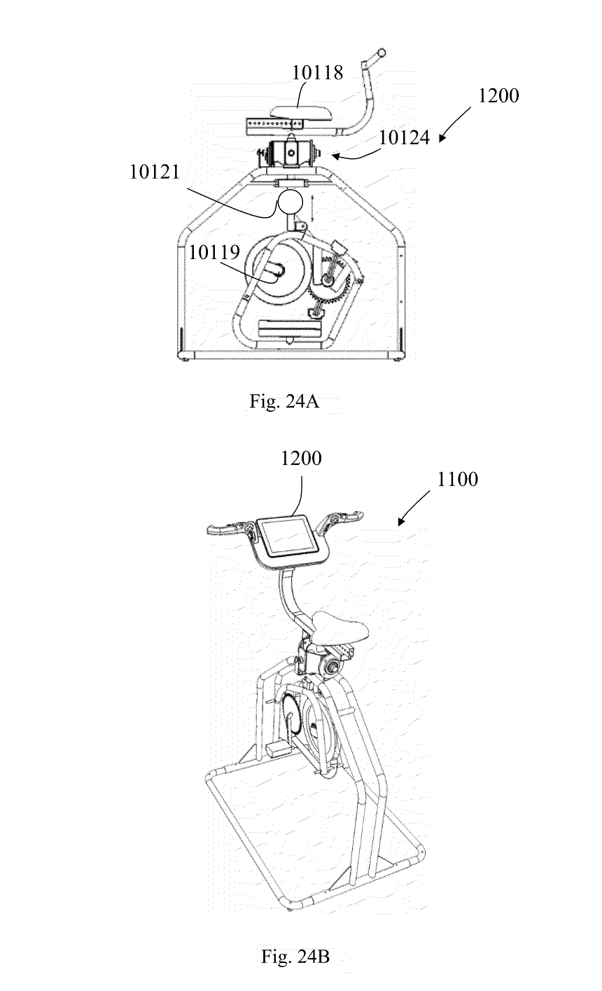

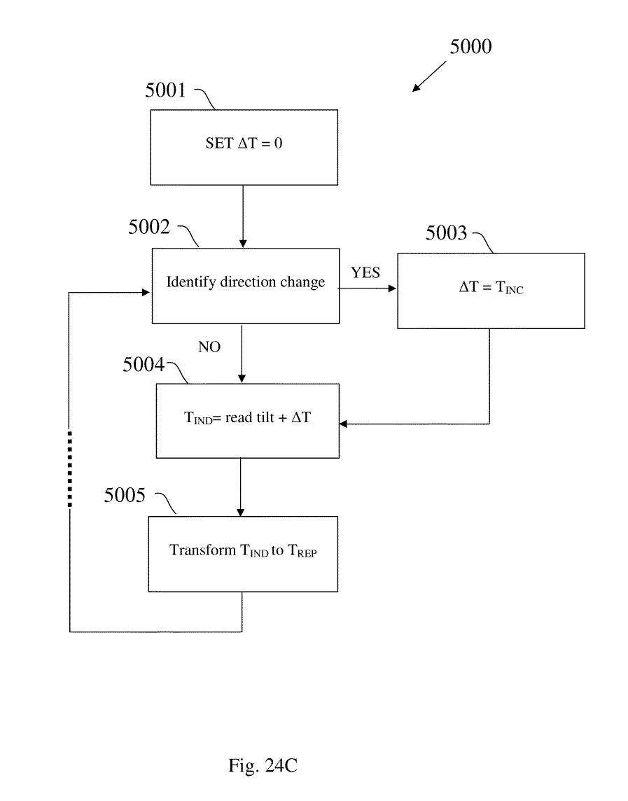

Attention is drawn to FIG. 24A. In an embodiment, a video game controller 1200 similar to the one described with respect to FIGS. 13 to 23 has an adjuster 10121 that is located between the seat 10118 and the lower part 10119 of the main portion 10112 where the foot levers 10120 are fitted. The adjuster 10121 is adapted to adjust the distance between the seat 10118 and the lower part 10119 of the main portion 10112 so that the controller 1200 can be adjusted for use with people having different heights. Notably, the adjuster 10121 is located below the support 10124 (and not between the support 10124 and the seat 10118) so that the distance between the seat 10118 and the center of mass of the person using the controller 1200 won't be affected when such a height adjustment is made. As a result, adjusting the controller 1200 with the adjuster 10121 will not affect the ability of a person “riding” the controller 1200 to successfully control a video game with which he interacts.

Attention is drawn to FIG. 24B. In an embodiment, a video game controller 1100 generally similar to the controllers described herein above can be fitted with a tablet personal computer 1200 that can function as the computerized device that communicates with the controller 1100. Values representative of the tilt of the controller's main portion or of the pedals or hand levers of the controller can be read or reported to the computerized device and a game being controlled by the controller can be displayed on the screen of the tablet 1200. In an embodiment, a tablet 1200 incorporating a gyroscope may be fitted to the controller 1100 and the values representative of the tilt of the controller's main portion may be directly used by the tablet to affect for example a game being played and viewed on the tablet.

The tilting of the main portion of the various embodiments of the controller of the present invention relative to the ground face may be detected by one or more potentiometers or encoders and an electrical sensor may be used for detecting the velocity and direction of rotation of the pedals of the controller. A program running on a processor of the controller may be used to transform the values read by the potentiometers or sensors to values that are reported to the video game console with which the controller is used. In an embodiment, the controller can also be fitted with a transmitting unit for transmitting signals to the video game console with which the controller is interacting. In addition, in some embodiments the controller can be equipped with a WIFI device for updating for example: the software program transforming values read by the potentiometers or sensors to those reported, for transmitting scores of games played and/or for transmitting physiological parameters that are measured from the person using the controller.

The controller of the various embodiments of the present invention may be used to control and interact with a video game console that may be initially configured to interact with a game controller that is designed to be held in the hand. A non binding example of such a game controller may be the gamepad game controller. Typically, joysticks of such handheld game controllers are designed to tilt to angles which are larger than the angles to which the main portion of the controller of the present invention is designed to tilt. The main portion of the controller may be limited to tilt for example to about 15° relative to a normal to the ground face which has been found to be a range in which the person being tilted still feels comfortable. A joystick of the handheld controller on the other hand may easily tilt to angles of about 45° relative to its normal position.

Therefore, in an embodiment of the present invention, a software program implementing an algorithm may used to transform the angle of tilt of an embodiment of the main portion of the controller of the present invention to a larger value that is transmitted to the video game console so that the range of tilt angles of the main portion will substantially cover the range of tilt angles of the joystick of the handheld controller.

In an embodiment, the algorithm used for transforming the read angle of tilt to that transmitted to the video game console may be implemented to function in a non linear manner. For example, the first 5° of tilt of the main portion may be transformed to a transmitted angle of tilt of 15° and a subsequent tilt of an additional 5° of the main portion may be transformed to a transmitted tilt of more than 15°. This non linear transformation of the angle of tilt of the main portion has been found to provide a smoother sense of movement in video games being controlled by the controller of the present invention.

In an additional embodiment, the algorithm used for transforming the values detected by potentiometers or sensors of the controller of the present invention to those transmitted to the video game console may be implemented in the following manner. Values representative to the rate of change in the direction of tilt of the main portion or to the rate of change in the direction of the rotation of the pedals may be transformed to larger values that are transmitted to the video game console. This has been found to compensate for the speed of response of the body of the person using the controller which is slower than the speed of response of the digits or thumbs of a hand using a handheld controller.

To compensate for the slower reaction of the human body (relative to a joystick) when a change in direction of tilt is made, attention is now drawn to FIG. 24C. Here a block diagram representing possible steps of an algorithm 5000 shows how read tilt angles of the main portion may in one possible embodiment of the present invention be analyzed and transformed to values representative of tilt that may be transmitted to the video game console.

In a first possible step 5001 of the algorithm, parameters used in the algorithm may be initialized and here one of these parameters ΔT can be seen to be optionally set to “zero”. In a subsequent possible step 5002 the algorithm identifies if a change in direction of tilt of the main portion is about to occur. If no such change is identified then the algorithm proceeds directly to step 5004 where a parameter T_{IND}, which is a parameter indicative of the tilt of the main portion, is assigned the value of read tilt of the main portion plus the value of ΔT. If step 5004 is reached when ΔT is equal to “zero” then T_{IND} is equal the read tilt angle of the main portion.

If on the other hand at step 5002 a change in direction that is about to occur by the person using the controller is identified, then the algorithm proceeds first to step 5003, where ΔT is set to be equal to a value of “increase” T_{INC}, and only after that, step 5004 is reached. Therefore if indeed a change in direction of tilt is identified then at step 5004 the value of T_{IND} will now be “increased” to be more than the actual read tilt angle, since ΔT is now equal to a value which is not “zero”.

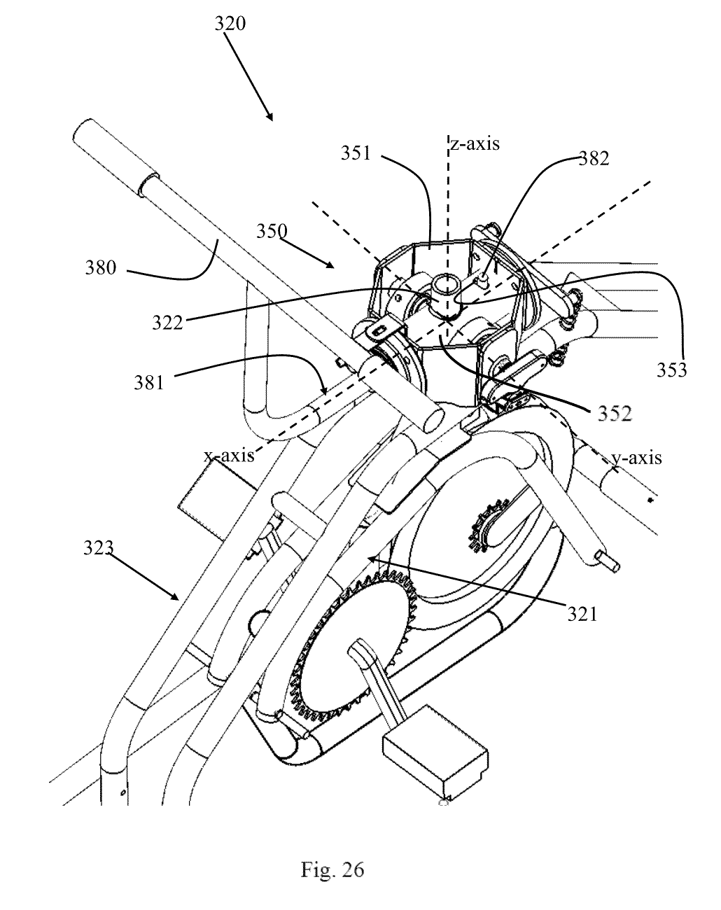

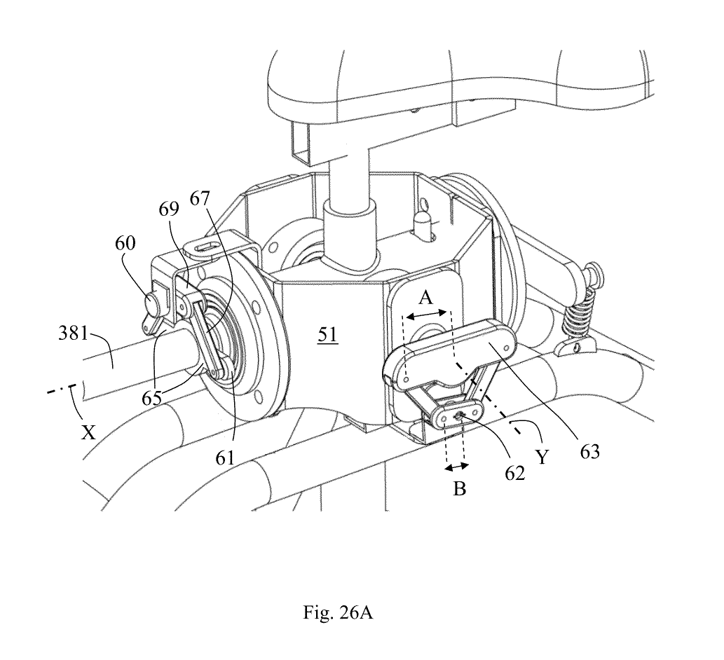

After establishing the value indicative of tilt T_{IND}, the algorithm may proceed to step 5005 where T_{IND} is transformed to a value representative of tilt T_{REP} which may then be transmitted to the video game. This transformation from T_{IND} to T_{REP} may be linear or non-linear and/or may be adapted to imitate a transformation that the video game being played was found to make to tilt values of a joystick with which it was originally programmed to work with. The transformation may accordingly be adapted to also transform tilt angles from a smaller range that the controller can tilt to larger angles of tilt typically available in a joystick—or additionally/alternatively this transformation from the smaller range that the controller may be limited to tilt in—to the larger tilt angles typically available in a joystick may be preformed when reading the tilt angles of the main portion by e.g. a “transmission” similar to that described with respect to FIG. 26A herein below. From step 5005 the algorithm may return to step 5002, and while doing so (as indicated by the “dotted line”) the algorithm may optionally perform additional steps such as optionally modifying the value of ΔT back to “zero” or to another value different from T_{INC}.

In a non-binding numerical example, if after tilting the main portion in a first direction by a first read angle of e.g. 10° (relative to an un-tilted state), a change in direction of tilt is identified at step 5002 of the algorithm, then a subsequent read second angle of tilt in an opposing second direction of e.g. 15° may be “increased” by software at steps 5003 and 5004 to have an “increased value” T_{IND} indicative of tilt of the second angle which is used for determining the angle value T_{REP} transmitted to the video game.

In an embodiment, change in direction of tilt may be identified if the main portion halts for a “slight pause” after tilting the first angle before starting again to tilt, and/or if after tilting the first angle and pausing—a “slight additional tilt” in the first direction is made before the main portion halts again before tilting in the second direction. Optionally the “slight pause” may be up to about 200 msec and preferably up to about 100 msec. And optionally the “slight additional tilt” may be up to about 1° and preferably up to about 0.5°. It is noted that both the “slight pause” and/or the “slight additional tilt” have been found by inventors to represent a physical phenomena that precedes a change in direction made by a human person using various embodiments of the controller.

In an embodiment, the second angle may optionally be increased by a value T_{INC} that is equal to the read value of the first angle, which in the example here provided may mean that the second read angle of 15° may be “increased” to an “increased value” T_{IND} indicative of tilt of 25° (i.e. 15°+10°). If the read angle of 15° would have translated to a first transformed angle representative of tilt T_{REP} transmitted the video game, then the “increased value” of 25° now translates to a second transformed angle representative of tilt T_{REP} which represents a more drastic change in tilt then that which actually occurred. And the purpose of this more drastic change in direction that is transmitted to the video game is accordingly in order to compensate for the slower reaction of the human body in relation to a hand held joystick.

In some embodiments of the present invention, the controller may be fitted as mentioned above with a tablet personal computer that incorporates a gyroscope that can detect the angle of tilt of the main portion. In cases where the game being controlled runs also on the tablet personal computer the following transformation may be required so that the game will run properly. In some cases, when playing a game on such a tablet personal computer the tablet is first placed parallel or vertical to the ground face and from that position the tablet can be moved for interacting with the game. In the controller of the present invention the tablet as seen in FIG. 24B is oriented at an angle to the ground face so that the person using the controller can conveniently view its display. Therefore, in some cases, it may be required to transform and/or fix the values at which the tablet is oriented relative to the ground face when the main portion is not tilted, to values that represent placement of the tablet at a parallel or a vertical position relative to the ground face so that the game that is run on the tablet will function properly.

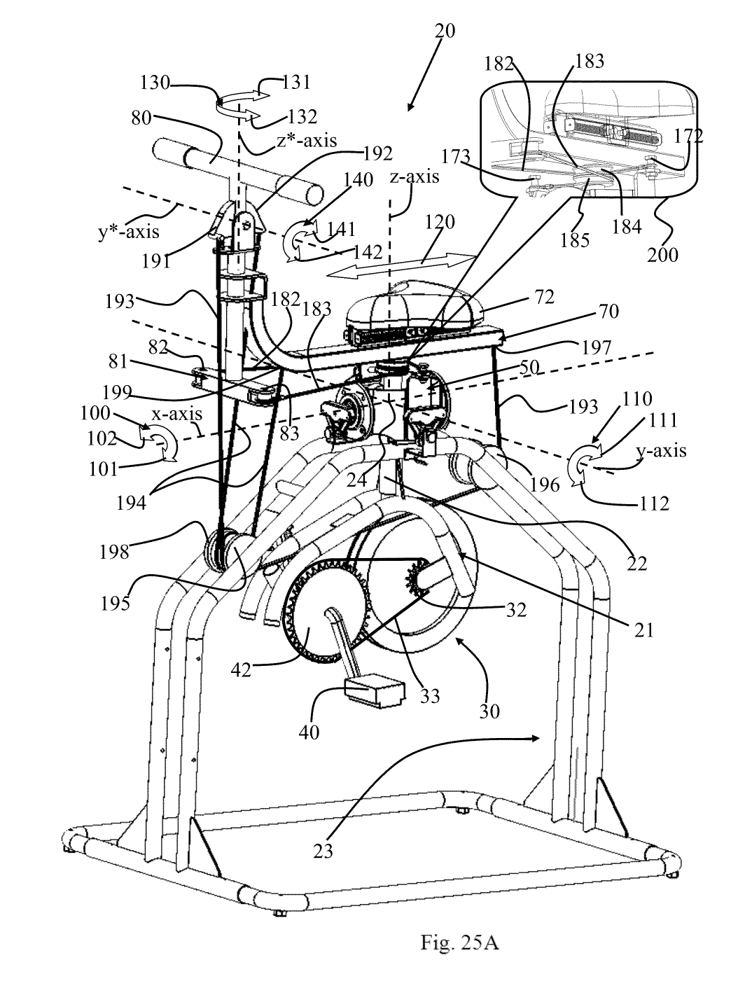

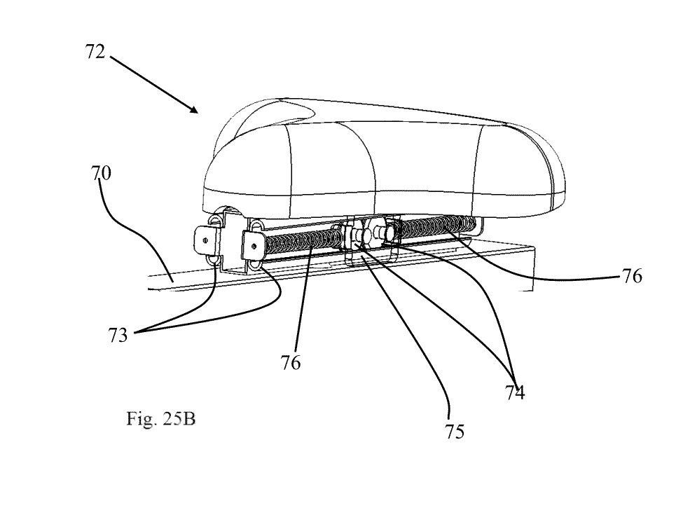

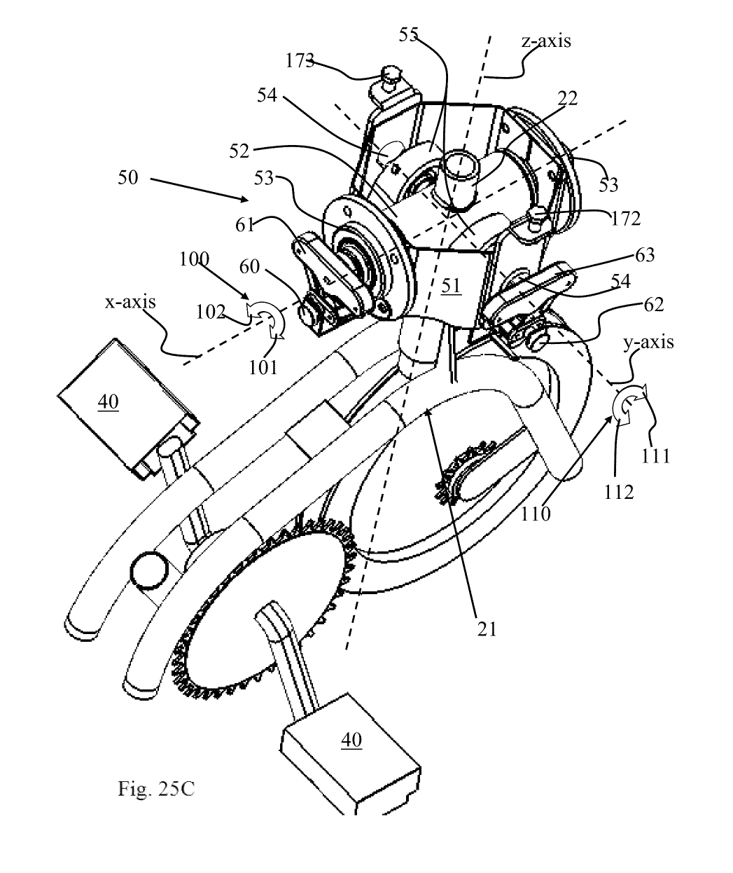

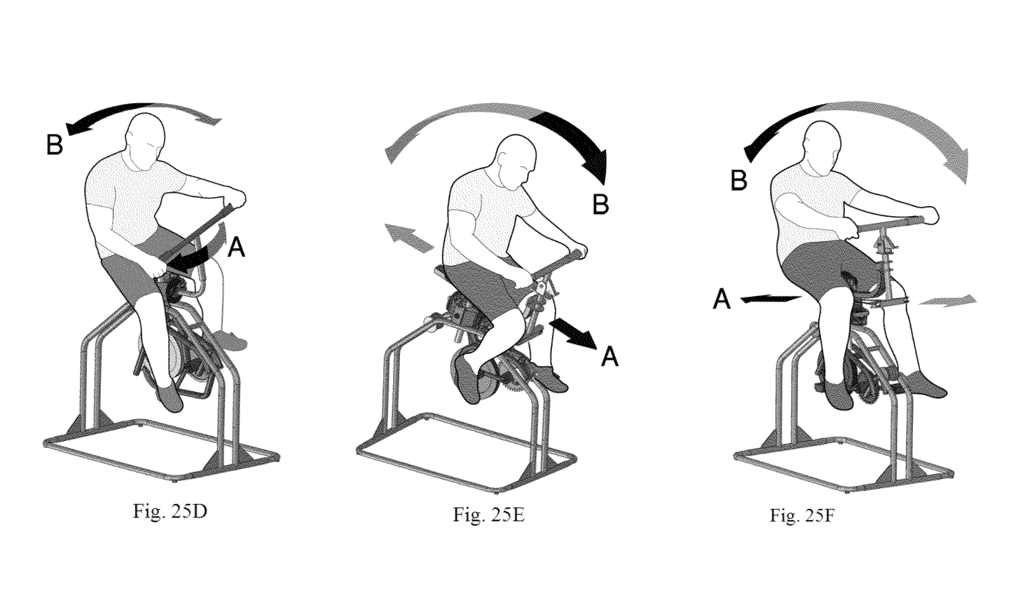

FIG. 25A schematically shows a video game controller (or HMI device) 20, here in the form of an exercise bicycle also referred to as an “HMI exercycle”, that is configured to interface a user (not shown) with a computer game, in accordance with an embodiment of the invention.

Controller 20 optionally comprises a resistance wheel 30 having a resistance wheel gear 32 and foot pedals 40, only one of which is shown in FIG. 25A, connected to a pedal gear 42 that are mounted to a cycle frame 21 having a stem 22. A toothed drive belt 33 couples resistance wheel gear 32 to the pedal gear 42 so that the gears turn together and torque required to pedal and rotate the pedal gear is substantially determined by resistance of resistance wheel 30 to rotation. Resistance wheel 30 may comprise any of various resistance wheels known in the art that have, optionally, adjustable resistance to rotation. Resistance wheel 30 may for example comprise an eddy current resistance wheel and/or a friction brake resistance wheel.

Stem 22 is fixed to a “support” that in this embodiment is in the form of a gimbal assembly 50 to which a user support beam 70 is fixed. Gimbal assembly 50 is in the form of a set of two “gimbals” and is mounted to a floor stand or base 23 and configured to enable clockwise and counterclockwise tilt/rotation of a “main portion” of controller 20 upon which a person interacting with the controller is received. The clockwise and counterclockwise rotations that gimbal assembly 50 enables is to stem 22, and thereby to e.g. cycle frame 21 and user support beam 70, about an x-axis and a y-axis of a Cartesian coordinate system having an origin 24 in the gimbal assembly and a z-axis parallel to stem 22.

Directions of rotation about x and y-axes are indicated by curved block arrows 100 and 110 respectively. Arrowheads 101 and 111 of block arrow 100 and 110 respectively indicate clockwise rotation relative to the x-axis and the y-axis. Similarly arrowheads 102 and 112 of block arrows 100 and 110 respectively indicate counterclockwise rotation relative to the x-axis and the y-axis. An angle of rotation about the x-axis may be referred to as a “roll angle”. An angle of rotation about the y-axis may be referred to as a “pitch angle”.

A user seat 72 and handlebars 80, also e.g. belonging to the “main portion” of controller 20, are optionally mounted to support beam 70. Optionally, seat 72 is mounted to the support beam so that the seat may slide in directions indicated by double headed block arrow 120 along the user support beam. An enlarged view of seat 72 and a portion of support beam 70 are schematically shown in FIG. 25B and features of the seat and components of controller 20 connected to the seat are discussed with reference to FIG. 25B.

In an embodiment of the invention, to enable user seat 72 to slide along support beam 70, the user seat is coupled to two guide rails 73 (most clearly shown in FIG. 25B) mounted to support beam 70. The seat is coupled to each guide rail 73 by a pair of wheels 74 that seat in the guide rail and are attached to the seat by a guide plate 75. In the perspective of FIG. 25B only one guide plate 75 and pair of wheels 74 are schematically shown and the guide plate is shown transparent to show wheels 74. Optionally, return springs 76 are attached to guide rails 73 and wheels 74 to aid in returning seat 72 to a central location along guide rails 73.

Handlebars 80 are mounted to support beam 70 so that the handlebars are rotatable about an x*-axis and a z*-axis clockwise and counterclockwise relative to the respective axes in directions respectively indicated by curved block arrows 130 and 140. Arrowheads 131 and 141 of block arrows 130 and 140 respectively indicate clockwise rotation relative to the z*-axis and y*-axis respectively. Arrowheads 132 and 142 of block arrows 130 and 140 respectively indicate counterclockwise rotation relative to the z*-axis and y*-axis respectively. Details of the operation of gimbal assembly 50 and handlebars 70 are described and discussed below.

FIG. 25C schematically shows an enlarged view of gimbal assembly 50 and internal features of the gimbal assembly. Gimbal assembly 50 optionally comprises an external housing 51 and a gimbal shaft 52 that is journaled in two bearings 53 mounted to housing 51 so that shaft 52, and thereby cycle frame 21 and user support beam 70, are rotatable about the x-axis. Two axles 54 journaled in bearings 55 and constituting a second gimbal are mounted to floor stand 23 (stand 23 seen in FIG. 25A), and provide support to housing 50 so that the housing and thereby shaft 52, cycle frame 21, and user support beam 70 are rotatable about the y-axis. In other words, in an embodiment, gimbal assembly 50 may facilitate for e.g. gimbal shaft 52, cycle frame 21 and user support beam 70 both rotation (i.e. “roll”) about the x-axis and rotation (i.e. “pitch”) about the y-axis; while for e.g. housing 51 gimbal assembly 50 may facilitate only rotation (i.e. “pitch”) about the y-axis.

In an embodiment of the invention, a roll angle potentiometer or encoder 60 is coupled to shaft 52 and generates output signals that provide measures of roll angle of the shaft about the x-axis. Optionally, roll angle potentiometer 60 is coupled to shaft 52 by a roll angle delimiter 61 that limits magnitude of the roll angle and rotates a shaft (not shown) in the potentiometer responsive to roll angle of shaft 52. Similarly, a pitch angle potentiometer or encoder 62 may generate output signals that provide measures of pitch angle of housing 51 about the y-axis. Optionally, potentiometer 62 is coupled to housing 51 by a pitch angle delimiter 63 that may limit magnitude of the pitch angle and rotates a shaft (not shown) in pitch angle potentiometer or encoder 62 responsive to pitch angle of housing 51. Housing 51 comprises right and left cable lugs 173 and 172 respectively, preferably rigidly fixed to housing 51, the functions of which are described below.

With attention drawn to FIG. 26A, which is an enlarged portion of an embodiment of a controller shown in FIG. 26 (discussed later below), function of elements 60, 61, 62 and 63 applicable to many of the embodiments of the present invention (such as the those in FIGS. 13 onwards) will be discussed. Roll angle potentiometer or encoder 60 is coupled to shaft 381 to generate read output tilt signals that provide measures of roll angle of the shaft about the x-axis. Element 61 now functioning and referred to as a transmission 61 (and previously delimiter 61) rotates a shaft (not shown) in potentiometer 60 responsive to roll angle of shaft 381. Similarly, pitch angle potentiometer 62 may generate read output tilt signals that provide measures of pitch angle of housing 51 about the y-axis. Optionally, potentiometer 62 is coupled to housing 51 by an element 61 now functioning and referred to as a transmission 63 (and previously as delimiter 63) that rotates a shaft (not shown) in pitch angle potentiometer 62 responsive to pitch angle of housing 51.

As indicated in FIG. 26A for example with respect to potentiometer 60, coupling of shaft 381 to potentiometer 60 may be provided via two wings 65, two links 67 and a swing 69 of transmission 61. Each wing 65 extends away from shaft 381 to an end where it is connected via a link 67 to a respective terminal side of wing 69, with wing 69 in turn being connected at its center to the shaft of potentiometer 60. Similar coupling via two wings, two links and a swing may be provided also between housing 51 and the shaft of potentiometer 62. Now by choosing appropriate dimensions for the wings 65 and swing 69, the actual tilt in roll or pitch directions of various embodiments of a controller of the present invention, may be magnified generally by a proportion between the values “A” and “B” indicated with respect to transmission 63 in FIG. 26A. “A” being a distance between an axis about which tilt in the roll or pitch direction occurring, and “B” being a distance between an axis about which a potentiometer or encoder measures roll or pitch and a terminal side of the swing connected to the potentiometer or encoder.

By choosing a value of “A” which is for example three times larger than “B” a magnification of about 1 to 3 between actual tilt and read tilt angles at the potentiometer may be provided. In is noted that in the embodiments of the transmissions here shown the magnification may vary slightly with change in tilt however will be generally about the ratio between “A” and “B”. Since embodiments of the controller of the present invention may be limited to tilt only up to a maximal angle where a human user interacting with the controller still feels comfortable, it has been found that this magnification may be required in order to enable embodiments of the controller on the one hand to be limited in tilt (optionally up to about 15° from a normal to the ground face) while on the other hand still have a range of read tilt angles with an angle sensitivity required for properly play a video game (in particular of the type designed to be played with a hand held joystick).

Preferably the magnification provided by the relation between “A” and “B” is generally similar to a ratio between a maximal angle that a joystick and a controller in accordance with an embodiment of the invention may be able to tilt. For an embodiment of a controller with a preferable maximal tilt angle of about 15° which is configured to control a video game originally designed to be played by a joystick having a maximal typical tilt angle of about 45°; the ratio between 45° and 15° which is 3:1 may also be the preferable ratio between “A” and “B”.

With attention drawn back to the embodiments of FIGS. 25, handlebars 80 are connected to a lower cross-bar 81 having ends 82 and 83 to which right and left “roll” cables 182 and 183 (FIG. 25A) are respectively attached. Right roll cable 182 loops around a pulley wheel 184 which is rotatably mounted to stem 22 or an extension thereof, and is anchored to left cable lug 172, shown in FIG. 25C and enlarged in an inset 200 of FIG. 25A, of an area above gimbal housing 51. Left roll cable 183 loops around a pulley wheel 185 rotatably mounted to stem 22, or an extension thereof, and is anchored to right cable lug 173 (shown in inset 200) of an area above gimbal housing 51.

Rotating handlebars 80 clockwise, that is in a direction indicated by arrowhead 131 of block arrow 130, about the z*-axis operates to possibly urge e.g. stem 22 and thereby seat 72 to tilt/roll towards cable lug 173 which is kept from rolling since it is fixed to housing 51, and this results in a lengthening of a distance between end 83 of cross-bar 81 and the z-axis (which passes through the center of pulley wheel 185 and stem 22) and a shortening of a distance between the z-axis and right hand cable lug 173. As a result, rotating handlebars 80 clockwise rotates/rolls shaft 52 (FIG. 25C), stem 22, and user seat 72 (as well as handlebars 80 and cycle frame 21) counterclockwise in a direction indicated by arrowhead 102 of block arrow 100.

Similarly, rotating handlebars 80 counterclockwise, that is in a direction indicated by arrowhead 132 of block arrow 130, about the z*-axis operates to possibly urge e.g. stem 22 and thereby seat 72 to tilt/roll towards cable lug 172 which is kept from rolling since it is fixed to housing 51, and this results in a lengthening a distance between end 82 of cross-bar 81 and the z-axis and a shortening of a distance between the z-axis and left hand cable lug 172. As a result, rotating handlebars 80 counterclockwise rotates/rolls shaft 52, stem 22, and user seat 72 (as well as handlebars 80 and cycle frame 21) clockwise in a direction indicated by arrowhead 101 of block arrow 100.

It is noted that in the above discussion and in FIG. 25A handlebars 80 are coupled to gimbal assembly 50 by two roll cables. However, practice of the invention is not limited to two roll cables. For example, a single roll cable fixed at ends 82 and 83 of cross-bar 81 or passed completely around a pulley that rotates about the z*-axis when handlebars 80 are rotated may be used in accordance with an embodiment of the invention to generate changes in roll angle of support beam 70.

Whereas a user may rotate shaft 52 (FIG. 25C) of gimbal assembly 50 to change his or her roll angle by rotating handlebars 80, the user may also rotate shaft 52 clockwise and counterclockwise, and change roll angle by shifting body weight. A user operating controller 20 to play a computer game may therefore simulate turning left or right by simultaneously shifting weight and turning handlebars 80 to mimic turning a bicycle or motorcycle by shifting weight and steering handlebars.

By both shifting weight and turning handlebars 80 a user may change the roll angle of shaft 52 about the x-axis fast enough so that signals that potentiometer 60 generates responsive to roll angle mimic signals generated by change of a roll pivot angle of a joystick. The user may therefore operate controller 20 as a “whole-body” joystick to keep up with and provide effective interaction with a changing environment of a computer game.

The physiological fact that shifting body weight alone in order to e.g. roll when interacting with a video/computer game, may be slower than forming same roll with a hand held joystick with which such a game may be designed to interact; may here be compensated (or partially compensated) mechanically by the hand held handlebars that participate in the formation of e.g. roll. The faster reacting movement of hands to rotate the handlebars e.g. counterclockwise about the z*-axis when the user wants to roll clockwise about the x-axis may “beat” (i.e. be faster than) the shifting of body weight clockwise about x-axis to form the roll, thereby causing a situation where seat 72 is urged (or at least initially urged) to roll clockwise about x-axis via roll cable 182 bearing against pulley wheel 184 that is coupled via stem 22 to seat 72.

In an embodiment, the physiological fact that shifting body weight alone in order to e.g. roll when interacting with a video/computer game, may be slower than (or insufficient for) forming same roll as with a hand held joystick with which such a game may be designed to interact; may additionally or alternatively be manipulated or compensated by software. For example, an algorithm used for transforming values detected by potentiometers sensing tilt (i.e. roll/pitch) of the controller to values transmitted to the video game, may be implemented e.g. in the following manner. Values representative to the rate of change in e.g. the direction of tilt of the device may be transformed to larger values that are transmitted to the video game, in order to compensate for the speed of response of the human body which is slower than the speed of response of the digits or thumbs of a hand using a handheld controller (e.g. joystick).

Additionally or alternatively, since a controller in accordance with various embodiments of the invention is designed to tilt (roll/pitch) to smaller angles than a joystick can tilt, in order to keep a person playing the controller from tilting to angles where he feels uncomfortable; a software program implementing an algorithm may be used to transform the tilt angle of the controller to a larger value that is transmitted to the video game so that the range of tilt angles of the controller will substantially cover the range of tilt angles of the joystick. For example, while the controller may be limited to either roll or pitch to about 10° or 15° a typical joystick may be designed to tilt up to about 45° from a central position. Additionally or alternatively this transform from the smaller range that the controller may be limited to tilt in—to the larger tilt angles typically available in a joystick may be preformed when reading the tilt angles of the main portion by e.g. a “transmission” similar to that described with respect to FIG. 26A herein above. In an embodiment, an algorithm used for transforming the read angle of tilt to that transmitted to the video game may be implemented to function in linear or non linear manners. For example, a first 5° of tilt of the controller (in pitch/roll direction) may be transformed to a transmitted angle of tilt of 15°; and a subsequent tilt of an additional 5° of the controller may be transformed to a transmitted tilt of more than 15°. This non linear transformation of the angle of tilt of the controller has been found to provide a smoother sense of movement in video games being controlled by embodiments of a controller of the present invention.

To compensate for the slower reaction of the human body (relative to a joystick) when a change in direction of tilt is made, attention is again drawn back to FIG. 24C. There accordingly a block diagram representing possible steps of an algorithm 5000 shows how read tilt angles of the main portion may in some possible embodiments of the present invention be analyzed and transformed to values representative of tilt that may be transmitted to the video game console.

In a first possible step 5001 of the algorithm, parameters used in the algorithm may be initialized and here one of these parameters ΔT can be seen to be optionally set to “zero”. In a subsequent possible step 5002 the algorithm identifies if a change in direction of tilt of the main portion is about to occur. If no such change is identified then the algorithm proceeds directly to step 5004 where a parameter T_{IND}, which is a parameter indicative of the tilt of the main portion, is assigned the value of read tilt of the main portion plus the value of ΔT. If step 5004 is reached when ΔT is equal to “zero” then T_{IND} is equal the read tilt angle of the main portion.

If on the other hand at step 5002 a change in direction that is about to occur by the person using the controller is identified, then the algorithm proceeds first to step 5003, where ΔT is set to be equal to a value of “increase” T_{INC}, and only after that, step 5004 is reached. Therefore if indeed a change in direction of tilt is identified then at step 5004 the value of T_{IND} will now be “increased” to be more than the actual read tilt angle, since ΔT is now equal to a value which is not “zero”.

After establishing the value indicative of tilt T_{IND}, the algorithm may proceed to step 5005 where T_{IND} is transformed to a value representative of tilt T_{REP} which may then be transmitted to the video game. This transformation from T_{IND} to T_{REP} may be linear or non-linear and/or may be adapted to imitate a transformation that the video game being played was found to make to tilt values of a joystick with which it was originally programmed to work with. The transformation may accordingly be adapted to also transform tilt angles from a smaller range that the controller can tilt to larger angles of tilt typically available in a joystick- or additionally/alternatively this transformation from the smaller range that the controller may be limited to tilt in—to the larger tilt angles typically available in a joystick may be preformed when reading the tilt angles of the main portion by e.g. a “transmission” similar to that described with respect to FIG. 26A herein above. From step 5005 the algorithm may return to step 5002, and while doing so (as indicated by the “dotted lines”) the algorithm may optionally perform additional steps such as optionally modifying the value of ΔT back to “zero” or to another value different from T_{INC}.

In a non-binding numerical example, if after tilting the main portion in a first direction by a first read angle of e.g. 10° (relative to an un-tilted state), a change in direction of tilt is identified at step 5002 of the algorithm, then a subsequent read second angle of tilt in an opposing second direction of e.g. 15° may be “increased” by software at steps 5003 and 5004 to have an “increased value” T_{IND} indicative of tilt of the second angle which is used for determining the angle value T_{REP} transmitted to the video game.

In an embodiment, change in direction of tilt may be identified if the main portion halts for a “slight pause” after tilting the first angle before starting again to tilt, and/or if after tilting the first angle and pausing—a “slight additional tilt” in the first direction is made before the main portion halts again before tilting in the second direction. Optionally the “slight pause” may be up to about 200 msec and preferably up to about 100 msec. And optionally the “slight additional tilt” may be up to about 1° and preferably up to about 0.5°. It is noted that both the “slight pause” and/or the “slight additional tilt” have been found by inventors to represent a physical phenomena that precedes a change in direction made by a human person using various embodiments of the controller.

In an embodiment, the second angle may optionally be increased by a value T_{INC} that is equal to the read value of the first angle, which in the example here provided may mean that the second read angle of 15° may be “increased” to an “increased value” T_{IND} indicative of tilt of 25° (i.e. 15°+10°). If the read angle of 15° would have translated to a first transformed angle representative of tilt T_{REP} transmitted the video game, then the “increased value” of 25° now translates to a second transformed angle representative of tilt T_{REP} which represents a more drastic change in tilt then that which actually occurred. And the purpose of this more drastic change in direction that is transmitted to the video game is accordingly in order to compensate for the slower reaction of the human body in relation to a hand held joystick.

With attention drawn back to FIGS. 25 the handlebars 80 optionally comprise up and down flanges 191 and 192 (FIG. 25A) respectively connected to up and down “pitch” angle cables 193 and 194 respectively. Up pitch cable 193 passes around pulley wheels 195 and 196 and is connected to support beam 70 at an aft end 197 of the beam. Down pitch cable 194 passes around a pulley wheel 198 and is connected to a fore end 199 of support beam 70.

Rotating handlebars 80 clockwise, that is in a direction indicated by arrowhead 141 of block arrow 140, about the y*-axis rotates up and down flanges 191 and 192 and operates to decrease a length of up pitch cable 193 between pulley 196 and aft end 197 of support beam 70 and increase a length of down pitch cable 194 between pulley 198 and fore end 199. As a result, rotating handlebars 80 clockwise about the y*-axis rotates support beam 70 clockwise about the y-axis in a direction indicated by arrowhead 111 of block arrow 110 and raises fore end 199 of the support beam. Similarly, rotating handlebars 80 counterclockwise, that is in a direction indicated by arrowhead 142 of block arrow 140, about the y*-axis operates to decrease a length of down pitch cable 194 between pulley 198 and fore end 199 of support beam 70 and increase a length of up pitch cable 193 between pulley 196 and aft end 197 of the support beam. As a result, rotating handlebars 80 counterclockwise about the y*-axis rotates support beam 70 counterclockwise about the y-axis in a direction indicated by arrowhead 112 of block arrow 110 and lowers fore end 199 of the support beam.

Whereas a user may rotate handlebars 80 to change his or her roll pitch angle, the user may also change pitch angle by shifting body weight to slide user seat 72 fore or aft along support beam 70. A user operating controller 20 to play a computer game may therefore simulate heading upwards and heading downwards pushing a joy stick forward or pulling a joystick backward by simultaneously shifting weight and rotating handlebars about the y*-axis. By both shifting weight and rotating handlebars 80, a user may change pitch angle of support beam 70 about the y-axis fast enough so that signals that potentiometer 62 generates responsive to pitch angle mimic signals generated by change of pivot angle of a joystick. The user may therefore operate controller 20 to keep up with and provide effective interaction with a changing environment of a computer game.

By way of example, FIGS. 25D-25F schematically show a user changing roll and pitch angles of a seat of a video game controller (or HMI device) in accordance with an embodiment of the invention.

In the above discussion and FIGS. 25A-25C a video game controller (or HMI device) 20 comprises handlebars 80 coupled to a gimbal assembly 50 by a configuration of cables and pulleys. However, practice of the invention is not limited to handlebars coupled to a gimbal assembly by control cables.

FIG. 26 schematically shows an embodiment of a video game controller (or HMI device) 320 comprising a handlebars 380 coupled to a “support”, in this embodiment in the form of a gimbal assembly 350, by a coupling shaft 381 rather than control cables. Gimbal assembly 350 here also provides for tilt/rotation of a “main portion” of controller 320 upon which a person interacting with the controller is received, relative to a floor stand or base 323. Gimbal assembly 350 comprises a shaft 352 journaled to a housing 351 so that the gimbal shaft is rotatable (i.e. rollable) about an x-axis. Housing 351 is mounted to the floor stand 323 similarly to the manner in which gimbal assembly 50 is mounted to floor stand 23 so that the housing is rotatable (i.e. pitchable) about a y-axis. Gimbal shaft 350 is connected to a stem 322 of a cycle frame 321 (hanging below the gimbal assembly) and a user seat (not shown) so that the cycle frame, user seat, and gimbal shaft rotate/roll together around the x-axis.

Coupling shaft 381 is rotatable/rollable about the x-axis and has a linchpin 382 that seats in a slot 353 formed in gimbal shaft 352. A suitable signal generator such as a potentiometer (not shown) is coupled to coupling shaft 381 and generates signals responsive to a roll angle of the coupling shaft that may be used to interface a user of controller 320 with a computer (not shown). Slot 353 has an arc length about the x-axis that is larger than a diameter of linchpin 382. As a result, handlebars 380 may be rotated about the x-axis without rotating gimbal shaft 352 for roll angles within a free range of angles defined by the arc length of slot 353 minus the diameter of linchpin 382. A user of controller 320 may therefore rapidly generate signals for interfacing with a computer simply by rapidly rotating handlebars 380 about the x-axis by angles within the free range of angles without having to rotate cycle frame 321.

In an embodiment of the invention, pedals 40 and pedal gear 41 of a video game controller (or HMI device) similar to controller 20 schematically shown in FIGS. 25A-25C are supported from resistance wheel 30 by a cantilever arm, and distance of the pedals from user seat 72 may be adjusted for user size by adjusting a pitch angle of the pedal gear relative to the resistance wheel.

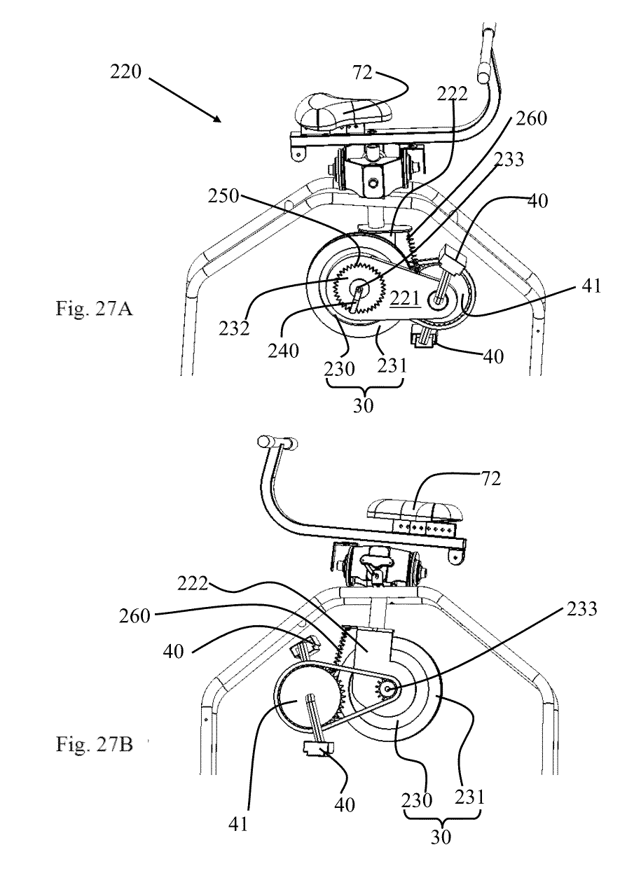

FIGS. 27A and 27B schematically show left and right hand side views of a portion of a video game controller (or HMI device) 220, here again in the form of an exercycle, having a pedal gear 41 and associated pedals 40 coupled to a resistance wheel 30 by a cantilever arm 221 (right side view shown in FIG. 27A), in accordance with an embodiment of the invention. Right and left side views of controller 20 refer to sides of the controller on the right and left sides of a user (not shown) seated on user seat 72 of the controller.

Resistance wheel 30 is supported by a gusset plate 222 shown in FIG. 27B, which is connected to a gimbal assembly 50 by a stem 22. Optionally, gusset plate 222 is connected to a non-rotating hub 230 of resistance wheel 30 on which a rim wheel 231 of the resistance wheel rotates when a user pedals to turn pedal gear 41.

Referring to the view of resistance wheel 30 shown in FIG. 27A, non-rotating hub 230 optionally comprises a locking gear 232, which may be switched from a locked position to an unlocked position optionally by manually operating an eccentric lever 240. An elastic element (not shown), such as a coil or leaf spring, seats between locking gear 232 and hub 230 and operates to push apart the locking gear and the hub. In the locked position, as schematically shown in FIG. 27A, eccentric lever 240 lies along locking gear 232 and opposes the action of the elastic element to press the locking gear to the hub. When pressed to hub 230 locking gear 232 seats in an optionally toothed recess 250 of cantilever arm 221 having teeth that mesh with the teeth of the locking gear and locks the eccentric arm to the hub. Raising eccentric lever 240 frees the elastic element between locking gear 232 and hub 230 to push out and unseat the locking gear from the recess in cantilever arm 222 and unlock the cantilever arm from the hub. When unlocked, cantilever arm 221 may be rotated, optionally about a center 233 of resistance wheel 30, to adjust distance of pedals 40 from user seat 72 to a desired distance. Upon adjustment to the desired distance, cantilever arm 222 may be locked in position by lowering eccentric lever 240 to lie prone on hub 230. To prevent cantilever arm from dropping towards the floor when eccentric lever is raised to disengage the cantilever arm from hub 230 a return spring 260 rotates cantilever arm upwards.

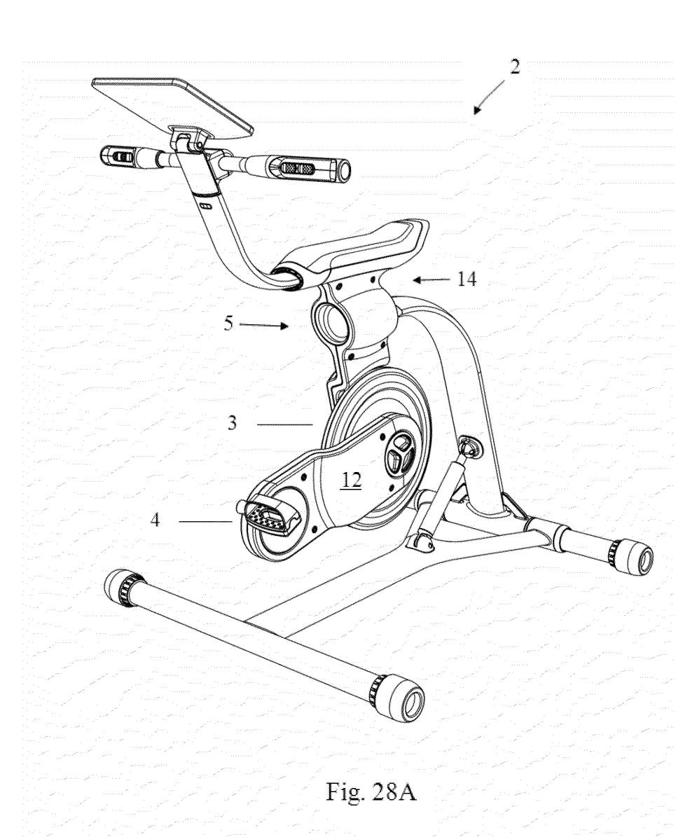

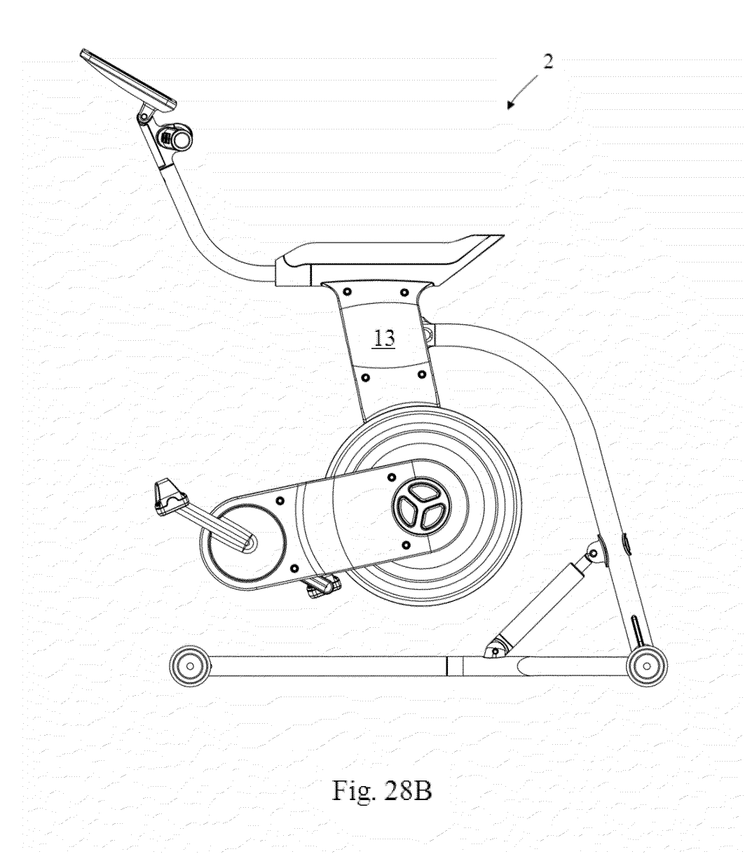

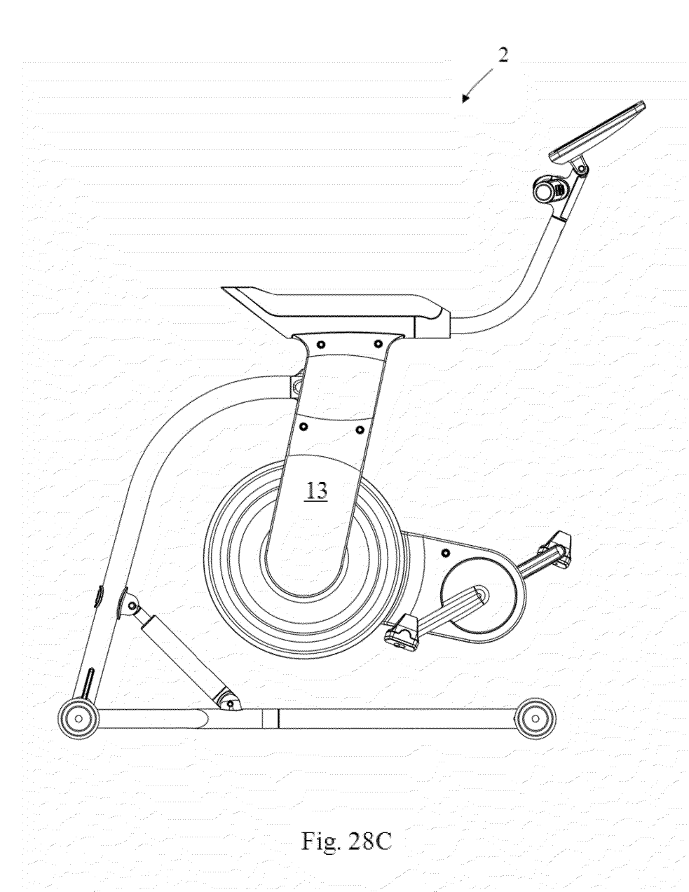

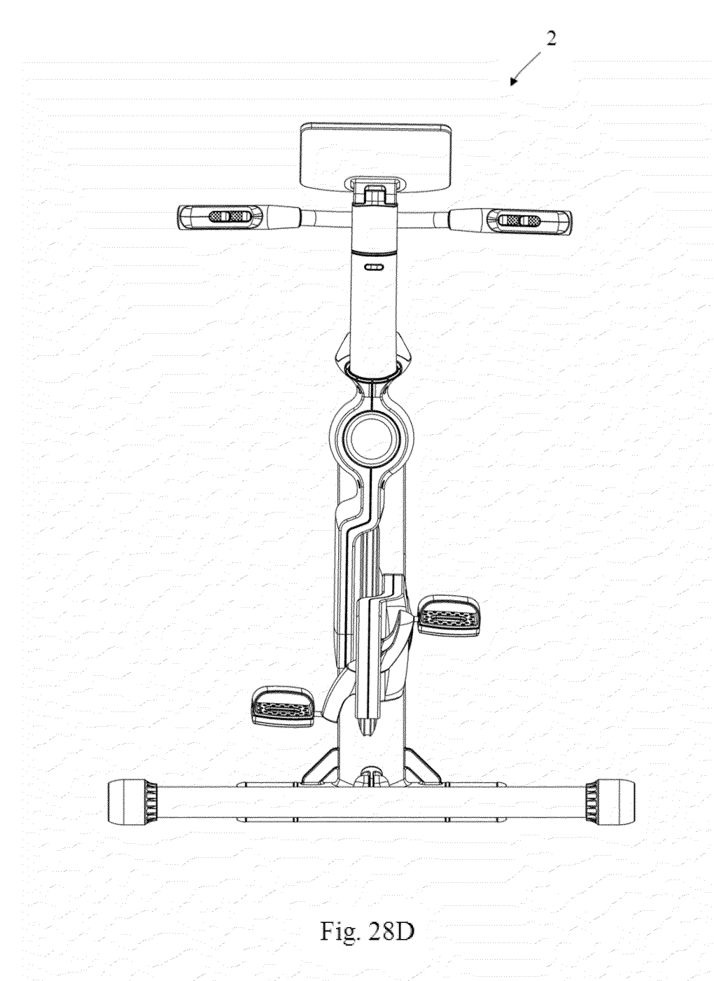

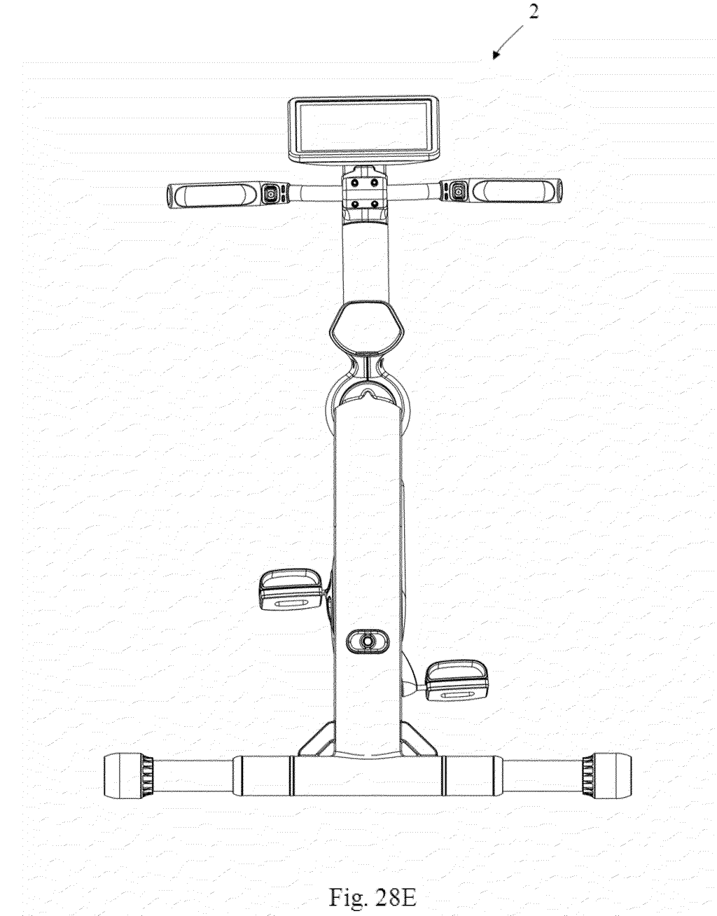

FIGS. 28A to 28E show perspective, right hand side, left hand side, front and back views, of a video game controller (or HMI device) 2, here again in the form of an exercycle, having a pedal gear 4 and associated pedals coupled to a resistance wheel 3 by a cantilever arm 12 in accordance with an embodiment of the invention. Cantilever arm 12 can be pivoted to increase or decrease a distance of the pedals from a seat of the controller and resistance wheel 3 is supported by a gusset plate 13 which is connected to a gimbal assembly 5 by a stem 14. Other parts of this embodiment may be apparent from the description provided above with respect to the generally similar embodiment of e.g. FIGS. 27A and 27B.

Whereas the above discussion and figures referred to in the discussion describe a video game controller (or HMI device) for use as a whole-body joystick for interfacing with a computer, a whole-body joystick may be configured in other than a video game controller (or HMI device) in accordance with an embodiment of the invention. For example, a treadmill supported by a suitable gimbal assembly or rotatable platform may be configured as a whole body joystick to generate signals that mimic joystick computer control signals in accordance with an embodiment of the invention. Also, in an embodiment a mere seat or stand supported by a suitable gimbal assembly, possible with an additional means for physical interacting of the user with the device (such as hand levers or handle bar), may be configured as a whole body joystick to generate signals that mimic joystick computer control signals in accordance with an embodiment of the invention.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although the present embodiments have been described to a certain degree of particularity, it should be understood that various alterations and modifications could be made without departing from the scope of the invention as hereinafter claimed.

1. A video game controller comprising a main portion that is adapted to receive a person interacting with the controller, the controller comprising a support about which the main portion can be tilted relative to a ground face while maintaining the person interacting with the controller only facing substantially the same direction, the person affecting the tilt by shifting of weight and the controller being adapted to communicate values representative of the tilt to a video game being controlled, wherein the main portion comprises a seat upon which the person is seated and the support is located between the seat and the ground face at a position more proximal to the seat and adjacently below the seat.

2. The video game controller according to claim 1, wherein the main portion comprises also foot levers for interaction with the feet of the person using the controller, and the support is located between the seat and the foot levers at a position more proximal to the seat and adjacently below the seat, and wherein a distance of the foot levers from the seat is adjustable by moving the foot levers towards or away from the seat.

3. The video game controller according to claim 1, wherein the person interacting with the controller can affect the tilting of the main portion also by moving the seat, wherein moving the seat moves a center of mass of the person relative to the support.

4. The video game controller according to claim 1, wherein the main portion comprises a manually movable mechanism that is connected to an anchoring portion of the controller, the anchoring portion being unable to move in at least one given direction and manually moving the mechanism urges the main portion to tilt at least in the given direction.

5. A video game controller comprising a main portion that is adapted to receive a person interacting with the controller, the controller comprising a support about which the main portion can be tilted relative to a ground face while maintaining the person interacting with the controller only facing substantially the same direction, and the controller being adapted to communicate values representative of the tilt to a video game being controlled, the person interacting with the controller affecting the tilting of the main portion by shifting of weight, and the main portion comprising at least one movable segment, wherein
moving the at least one movable segment up to a limit affects only change to values representative of the tilt communicated to the video game and moving the at least one movable segment beyond the limit urges the main portion also to tilt.

6. The video game controller according to claim 5 and comprising a biasing mechanism that is adapted to urge the main portion to tilt towards an un-tilted position and the tilting of the main portion in at least some directions away from the un-tilted position is by the shifting of weight of the person interacting with the controller and/or by moving the segment to a position beyond the limit.

7. The video game controller according to claim 5, wherein the main portion comprises a seat and foot levers, the seat being adapted for seating of the person using the controller and the foot levers being adapted for interaction with the feet of the person using the controller, wherein the support is located between the seat and the foot levers at a position more proximal to the seat and adjacently below the seat.

8. The video game controller according to claim 7, wherein a distance of the foot levers from the seat is adjustable by moving the foot levers towards or away from the seat.

9. The video game controller according to claim 1, wherein the values representative of the tilt are created by taking a value indicative of read tilt of the main portion and transforming it to a different value that is communicated to the video game which is the value representative of tilt.

10. The video game controller according to claim 9, wherein a given range of tilt of the main portion is divided into at least two consecutive parts and a value of a read angle of tilt within the first part is transformed by increasing it by a first amount and a value of a read angle of tilt within the second part is transformed by increasing it by a second amount that is different from the first amount.

11. The video game controller according to claim 10, wherein the second part of tilt is more distal than the first part of tilt from a position of the main portion where the main portion is at an un-tilted state relative to the ground face, and the second amount is larger than the first amount.

12. The video game controller according to claim 9, wherein if a change in direction of tilt from a first direction towards an opposing second direction is identified, then for at least one subsequent read angle of tilt in the second direction, a value indicative of the read angle is greater than the actual read angle.

13. The video game controller according to claim 12, wherein a change in direction of tilt is identified if the main portion halts for a “slight pause” of up to about 200 msec after tilting in the first direction before starting again to tilt, and/or if after tilting in the first direction and then pausing a “slight additional tilt” of up to about 1° in the first direction is made before the main portion stops tilting again in the first direction.

14. A method for controlling a video game comprising the steps of:
providing a controller comprising a main portion that is adapted to receive a person interacting with the controller, the controller comprising a support about which the main portion can be tilted relative to a ground face while maintaining the person interacting with the controller only facing substantially the same direction, receiving a read value of tilt of the main portion, and transforming the read value to a value that is communicated to the video game which is different from the read value, wherein values of actual tilt of the main portion are magnified to provide values of read tilt of the main portion.

15. The method according to claim 14, wherein the person interacting with the controller can affect the tilting of the main portion by shifting of weight and by moving at least one movable segment of the main portion.

16. The method according to claim 15, wherein the at least one movable segment comprises a seat upon which the person is seated and moving the seat moves a center of mass of the person relative to the support.

17. The method according to claim 15, wherein the at least one movable segment comprises a manually movable mechanism, the manually movable mechanism being connected to an anchoring portion of the controller that is unable to move in at least one given direction and manually moving the mechanism urges the main portion to tilt at least in the given direction.
